(19) United States
(12) Patent Application Publication
(10) Pub. No.: US 2025/0356353 A1
(43) Pub. Date: Nov. 20, 2025

(54) BLOCKCHAIN-BASED DATA PROCESSING METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventor: Zhiyong LIAO, Shenzhen (CN)

(21) Appl. No.: 19/281,739

(22) Filed: Jul. 27, 2025

Related U.S. Application Data
(63) Continuation of application No. PCT/CN2023/133703, filed on Nov. 23, 2023.

(30) Foreign Application Priority Data
May 31, 2023 (CN) 202310647015.6

(51) Int. Cl. G06Q 20/40

(52) U.S. Cl. CPC G06Q 20/401

(57) ABSTRACT

A method includes transmitting an original reading request carrying transaction attribute information of target transaction data to a node device in a blockchain network, receiving an off-chain reading request transmitted by the node device, reading a transaction data packet from a target network device according to the off-chain reading request, forwarding the transaction data packet to the node device to verify validity of the transaction data packet to obtain a verification result, and receiving, in response to the verification result indicating that the transaction data packet is valid, the target transaction data returned by the node device.

### CROSS-REFERENCE TO RELATED APPLICATIONS

This application is a continuation of International Application No. PCT/CN2023/133703, filed on Nov. 23, 2023, which claims priority to Chinese Patent Application No. 202310647015.6, entitled “BLOCKCHAIN-BASED DATA PROCESSING METHOD AND APPARATUS, DEVICE, AND STORAGE MEDIUM” filed with the China National Intellectual Property Administration on May 31, 2023, which is incorporated by reference in its entirety.

### FIELD OF THE TECHNOLOGY

This application relates to the fields of blockchain and the like, and in particular, to a blockchain-based data processing method and apparatus, a device, and a storage medium.

### BACKGROUND OF THE DISCLOSURE

The blockchain is a new application mode of computer technologies such as distributed data storage, peer-to-peer transmission, a consensus mechanism, and an encryption algorithm. The blockchain is essentially a decentralized database and includes a string of data blocks generated through a cryptographic method. Each data block contains multiple pieces of transaction data to verify the validity of the transaction data (anti-counterfeiting) and generate a next block. As time goes by, transaction data stored on the blockchain increases accordingly, causing a relatively large storage pressure on the blockchain, and even causing some transaction data to be unable to be stored.

### SUMMARY

In accordance with the disclosure, there is provided a data processing method including transmitting an original reading request about target transaction data to a node device in a blockchain network to cause the node device to invoke a business function in a cross-chain communication protocol according to the original reading request. The original reading request carries transaction attribute information of the target transaction data. The method further includes receiving an off-chain reading request transmitted by the node device. The off-chain reading request is generated by the node device through the business function and according to the transaction attribute information and device attribute information of a target network device. The device attribute information is obtained by the node device querying the cross-chain communication protocol when determining, through the business function, that the target transaction data is off-chain data of the blockchain network. The target network device is configured to read the off-chain data of the blockchain network. The method also includes reading a transaction data packet from the target network device according to the off-chain reading request. The transaction data packet is read by the target network device from an external device associated with the blockchain network. The method also includes forwarding the transaction data packet to the node device, for the node device to verify validity of the transaction data packet based on a data verification function associated with the cross-chain communication protocol, to obtain a verification result, and receiving, in response to the verification result indicating that the transaction data packet is valid, the target transaction data returned by the node device. The target transaction data is obtained by the node device parsing the transaction data packet.

Also in accordance with the disclosure, there is provided a data processing method including receiving an original reading request about target transaction data. The original reading request is transmitted by a terminal device and carries transaction attribute information of the target transaction data. The method further includes invoking a business function in a cross-chain communication protocol according to the original reading request, querying, in response to the business function indicating that the target transaction data is off-chain data of a blockchain network, the cross-chain communication protocol of the blockchain network for device attribute information of a target network device configured to read the off-chain data of the blockchain network, generating an off-chain reading request in the business function according to the transaction attribute information and the device attribute information, and transmitting the off-chain reading request to the terminal device, for the terminal device to read a transaction data packet from the target network device according to the off-chain reading request. The transaction data packet is read by the target network device from an external device associated with a node device in the blockchain network. The method also includes receiving the transaction data packet transmitted by the terminal device, verifying validity of the transaction data packet according to a data verification function associated with the cross-chain communication protocol to obtain a verification result, parsing, in response to the verification result indicating that the transaction data packet is valid, the transaction data packet to obtain the target transaction data, and returning the target transaction data obtained through parsing to the terminal device.

Also in accordance with the disclosure, there is provided a computer device including a memory storing a computer program and a processor configured to execute the computer program to transmit an original reading request about target transaction data to a node device in a blockchain network to cause the node device to invoke a business function in a cross-chain communication protocol according to the original reading request. The original reading request carries transaction attribute information of the target transaction data. The processor is further configured to receive an off-chain reading request transmitted by the node device. The off-chain reading request is generated by the node device through the business function and according to the transaction attribute information and device attribute information of a target network device. The device attribute information is obtained by the node device querying the cross-chain communication protocol when determining, through the business function, that the target transaction data is off-chain data of the blockchain network. The target network device is configured to read the off-chain data of the blockchain network. The processor is also configured to read a transaction data packet from the target network device according to the off-chain reading request. The transaction data packet is read by the target network device from an external device associated with the blockchain network. The processor is also configured to forward the transaction data packet to the node device, for the node device to verify validity of the transaction data packet based on a data verification function associated with the cross-chain communication protocol, to obtain a verification result, and receive, in response to the verification result indicating that the transaction data packet is valid, the target transaction data returned by the node device. The target transaction data is obtained by the node device parsing the transaction data packet.

### BRIEF DESCRIPTION OF THE DRAWINGS

To more clearly illustrate the technical solutions in embodiments of this application, the drawings needed for the descriptions of the embodiments will be briefly introduced below. It is clear that the drawings described below are only some embodiments of this application, and a person skilled in the art may obtain other drawings according to these drawings without involving any inventive effort.

FIG. 1 is a schematic diagram of an architecture of a blockchain-based data processing system according to this application.

FIG. 2 is a schematic structural diagram of a blockchain according to this application.

FIG. 3 is a schematic diagram showing a scene of interaction among a terminal device, a target network device, and a node device in a blockchain network according to this application.

FIG. 4 is a schematic flowchart of a blockchain-based data processing method according to this application.

FIG. 5 is a schematic diagram showing a scene of generating a second off-chain reading request based on a uniform resource locator (URL) template according to this application.

FIG. 6 is a schematic flowchart of a blockchain-based data processing method according to this application.

FIG. 7 is a schematic diagram showing a scene of querying a balance of a user corresponding to a terminal device according to this application.

FIG. 8 is a schematic structural diagram of a blockchain-based data processing apparatus according to an embodiment of this application.

FIG. 9 is a schematic structural diagram of a blockchain-based data processing apparatus according to an embodiment of this application.

FIG. 10 is a schematic structural diagram of a computer device according to an embodiment of this application.

### DESCRIPTION OF EMBODIMENTS

The technical solutions in embodiments of this application are described in the following with reference to the accompanying drawings in the embodiments of this application. Apparently, the described embodiments are merely some rather than all of the embodiments of this application. All other embodiments obtained by a person skilled in the art based on the embodiments of this application without making inventive efforts shall fall within the scope of this application.

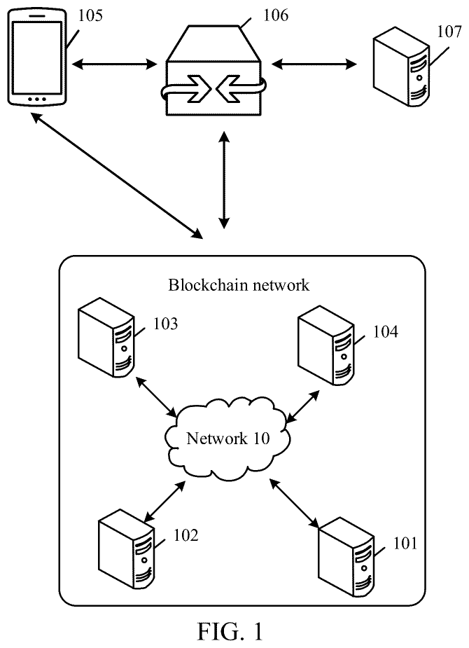

A blockchain-based data processing system applied to this solution is first introduced. FIG. 1 is a schematic structural diagram of a blockchain-based data processing system according to an embodiment of this application. The blockchain-based data processing system includes a blockchain network, a terminal device 105, a network device 106, and an external device 107.

The terminal device 105 may include a data processing application. The data processing application is configured to write transaction data to the blockchain network or read transaction data from the blockchain network. For example, the data processing application may be a blockchain application. The terminal device 105 is communicatively connected to the network device 106 and node devices in the blockchain network so that the terminal device 105 can exchange information with the network device 106 and the node devices in the blockchain network.

The external device 107 may be a device configured to store off-chain data of the blockchain network. The external device 107 may be a node device in another blockchain network or may be a database device. The database device may be a node device in a non-blockchain network. For example, the database device may be a device specifically configured to store transaction data.

The network device 106 refers to a device configured to read the off-chain data from the external device 107. The network device 106 is equivalent to an entry for reading the off-chain data from the external device 107 and may specifically be a gateway device. The network device 106 has network connections to the external device 107 and the node devices in the blockchain network so that the network device 106 may exchange information with the external device 107 and the node devices in the blockchain network.

The blockchain network is an end-to-end decentralized network including a plurality of node devices. The node devices in the blockchain network may be referred to as background processing devices of the data processing application in the terminal device 105. The number of node devices in the blockchain network may be set according to an actual need and is not limited in this application. As shown in FIG. 1, an example in which the blockchain network includes four node devices is used for description. The four node devices are a node device 101, a node device 102, a node device 103, and a node device 104, respectively.

During normal operation, each node device may receive to-be-recorded transaction data and maintain the blockchain based on the received to-be-recorded transaction data. To ensure information intercommunication within the blockchain network, a network connection 10 may exist among the node devices in the blockchain network, and data transmission may be performed between the node devices through the network connection 10. For example, when any node device in the blockchain network receives the to-be-recorded transaction data, the other node devices in the blockchain network verify the to-be-recorded transaction data according to a consensus algorithm. After the verification succeeds (that is, after a consensus is reached), the to-be-recorded transaction data is stored as data in the blockchain so that data stored in all node devices in the blockchain network is consistent.

Data or block transmission between the node devices may be performed through the foregoing network connection 10. The foregoing network connection between the node devices may be based on node identifiers. Each node device in the blockchain network has a corresponding node identifier and may store node identifiers of other node devices connected to the node device, so as to subsequently broadcast the obtained data or the generated block to other node devices according to the node identifiers of other node devices. For example, the node device 101 may maintain a node identifier list, which stores node names and the node identifiers of other node devices, as shown in Table 1.

TABLE 1

| Node name | Node identifier |
|---|---|
| Node device 101 | 117.xxx.xxx.174 |
| Node device 102 | 117. xxx.xxx.145 |
| . . . | . . . |
| Node device 111 | 117 .xxx.xxx.183 |
| Node device 112 | 117. xxx.xxx.125 |
| Node device 113 | 119. .xxx.xxx.234 |
| . . . | . . . |

The node identifier may be an Internet protocol (IP) address and any other piece of information that can be configured for identifying the node devices in the blockchain network. In Table 1, only the IP address is used as an example for description.

It is assumed that the node identifier of the node device 101 is 117.xxx.xxx.174. The node device 101 may transmit a data synchronization request to the node device 102 through 117.xxx.xxx.174, and the node device 102 may learn, through the node identifier 117.xxx.xxx.174, that the data synchronization request is transmitted by the node device 101. Similarly, the node device 102 may transmit transaction data A to the node device 101 through the node identifier 117.xxx.xxx.145, and the node device 101 may learn, through the node identifier 117. xxx.xxx.145, that the transaction data A is transmitted by the node device 102. Data transmission between other node devices is also the same. Therefore, details are not described one by one again.

A connection manner of the foregoing network connection is not limited. The network connection be a direct or indirect connection in a wired communication manner, may be a direct or indirect connection in a wireless communication manner, or may be a connection in other connection manners. This is not limited in this application herein.

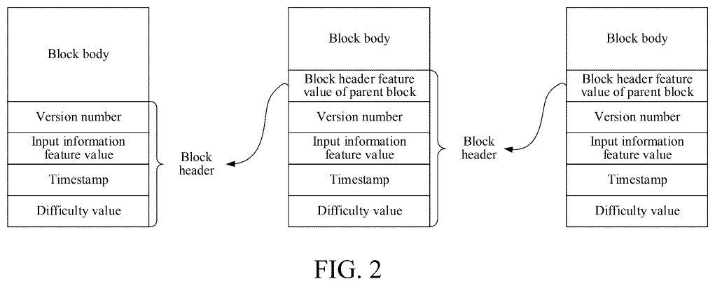

As shown in FIG. 2, the blockchain includes a plurality of blocks. A genesis block includes a block header and a block body. The block header stores an input information feature value, a version number, a timestamp, and a difficulty value. The block body stores input information. A next block of the genesis block uses the genesis block as a parent block and also includes a block header and a block body. The block header stores an input information feature value of a current block, a block header feature value of the parent block, a version number, a timestamp, and a difficulty value. By analogy, block data stored in each block in the blockchain is associated with block data stored in the parent block, thereby ensuring the security of the input information in the blocks.

To reduce the storage pressure of the blockchain network, some transaction data is stored off-chain in the blockchain network, that is, data stored off-chain in the blockchain network may be referred to as off-chain data. To enable the node device in the blockchain network to orderly store the transaction data off-chain, and a terminal device to securely read the off-chain data in the blockchain network, the node device in the blockchain network may pre-deploy a cross-chain communication protocol. The cross-chain communication protocol is configured for instructing to read the off-chain data related to the blockchain network on-chain. Specifically, the cross-chain communication protocol includes the following content:

(1) a business function for the node device to issue an off-chain reading request to the terminal device; (2) device attribute information and a request generation template of a network device associated with the blockchain network, where the network device may be an entry configured to read the off-chain data from an external device, and there may be one or more network devices; the request generation template of the network device refers to a request generation template adapted to the network device and is configured for generating an off-chain reading request adapted to the network device; the off-chain reading request adapted to the network device refers to an off-chain reading request that can be successfully parsed by the network device, and the request generation template includes device attribute information of a corresponding network device; the device attribute information may include an IP address (URL address), a device name, and the like of the network device; and (3) a data verification function configured for verifying the off-chain data, where the data verification function is configured for indicating how to verify the validity of the off-chain data.

In some embodiments, the cross-chain communication protocol may be stored on the node device in the blockchain network in a form of a smart contract. The cross-chain communication protocol has a unique protocol identifier in the blockchain network, and the protocol identifier may alternatively be referred to as a protocol address (or a contract address). The smart contract may be a protocol defined in a digital form and needs to run in a trusted environment. The trusted environment may be a blockchain platform. The blockchain platform may be deployed on each node device in the blockchain network. That is, the blockchain is established on the blockchain platform. The blockchain platform may be a back-end processing application of the data processing application in the foregoing terminal device 105. The blockchain platform may be configured to manage (for example, permission management) and maintain (for example, update or repair) the data processing application in the terminal device 105.

The node device 101, the node device 102, the node device 103, and the node device 104 may each be an independent physical server, a server cluster or distributed system including at least two physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal device 105 may be specifically an in-vehicle terminal, a smartphone, a tablet computer, a laptop computer, a desktop computer, a smart speaker, a screen speaker, a smart watch, and the like, but is not limited to thereto. The terminal device may be directly or indirectly connected to the server in a wired or wireless communication manner. Meanwhile, the number of terminal devices and the number of servers each may be one or at least two. This is not limited in this application. The network device 106 and the external device 107 may each be a server or a terminal device.

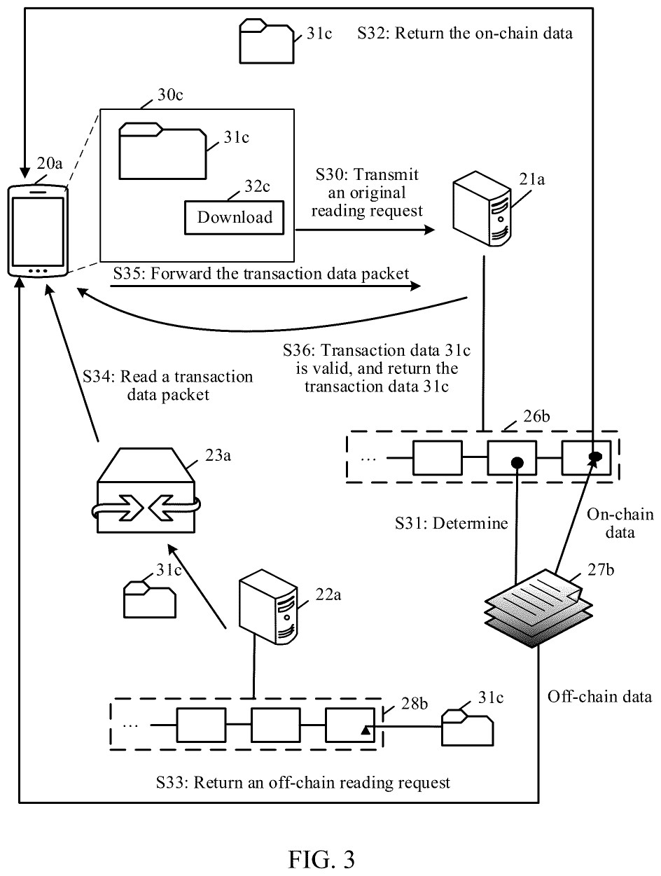

In this application, the device attribute information of the network device may include at least one of an IP address (or a URL address), a device name, or the like of the network device. The transaction attribute information of the target transaction data may include a data volume of the target transaction data, an object identifier of an object (such as a user or an institution) to which the target transaction data belongs, a purpose of the target transaction data, and the like. The object identifier may include a public key or an account (such as a payment account) of the object in the blockchain network. The blockchain-based data processing system shown in FIG. 1 can implement the blockchain-based data processing method in this application. Referring to FIG. 3, the terminal device 20a in FIG. 3 may be the terminal device 105 in FIG. 1. The node device 21a in FIG. 3 may be any node device in the blockchain network in FIG. 1, and a blockchain network to which the node device 21a belongs may be referred to as a blockchain network a. A blockchain 26b of the blockchain network a stores a cross-chain communication protocol 27b (which may alternatively be understood as that the cross-chain communication protocol 27b is deployed in the node device 21a). A node device 22a in FIG. 3 may be the external device 107 in FIG. 1. An example in which the external device is any node device in a blockchain network b is used for description. Each node device in the blockchain network b stores a blockchain 28b. A network device 23a in FIG. 3 may be the network device 106 in FIG. 1. As shown in FIG. 3, the blockchain-based data processing method may include the following operation S30 to operation S36.

S30: The terminal device 20a transmits an original reading request for transaction data 31c to the node device 21a. The terminal device 20a may display a data reading interface 30c of a data processing application. The data reading interface 30c may include to-be-downloaded transaction data 31c and a downloading control 32c in the blockchain network a. The transaction data 31c may be on-chain data or off-chain data. The on-chain data of the blockchain network a refers to transaction data stored in the blockchain 26b of the blockchain network a, and the off-chain data of the blockchain network a may be transaction data stored in an external device by a node device in the blockchain network a. The external device may be a node device in the blockchain network b associated with the blockchain network a, or may be a database device associated with the blockchain network a. The terminal device 20, in response to a trigger operation for the downloading control 32c in the data reading interface 30c, generates the original reading request about the transaction data 31c and transmits the original reading request to the server 21a. The terminal device 20a does not sense whether the transaction data 31c is on-chain data. Therefore, the original reading request may be an on-chain reading request for the transaction data 31c and carries transaction attribute information of the transaction data 31c. The transaction attribute information of the transaction data 31c may include a data volume of the transaction data 31c, an object identifier of an object (such as a user or an institution) to which the transaction data 31c belongs, a purpose of the transaction data 31c, and the like.

S31: The node device 21a determines, according to a business function in the cross-chain communication protocol 27b, whether the transaction data 31c is on-chain data (the business function may be obtained by invoking through a function name carried in the original reading request), performs operation S32 if the transaction data 31c is the on-chain data; and if the transaction data 31c is not the on-chain data, that is, the transaction data 31c is off-chain data, performs operation S33. Specifically, the node device 21a may further determine, according to an off-chain storage rule in the cross-chain communication protocol 27b, whether the transaction data 31c is the on-chain data. In an embodiment, when the off-chain data storage rule indicates that transaction data whose data volume is greater than a data volume threshold is stored off-chain, the node device 21a may obtain a data volume of the transaction data 31c from the transaction attribute information of the transaction data 31c, determine, when the data volume of the transaction data 31c is less than or equal to the data volume threshold, that the transaction data 31c is the on-chain data, and determine, when the data volume of the transaction data 31c is greater than the data volume threshold, that the transaction data 31c is the off-chain data. In an embodiment, when the off-chain data storage rule indicates that transaction data whose real-time level is less than a real-time level threshold is stored off-chain, the node device 21a may obtain the purpose of the transaction data 31c from the transaction attribute information of the transaction data 31c and determine, according to the purpose of the transaction data 31c, a real-time level of the transaction data 31c. If the real-time level of the transaction data 31c is greater than or equal to the real-time level threshold, it is determined that the transaction data 31c is the on-chain data. If the real-time level of the transaction data 31c is less than the real-time level threshold, it is determined that the transaction data 31c is the off-chain data. In an embodiment, when the off-chain data storage rule indicates that transaction data whose security level is less than a security level threshold is stored off-chain, the node device 21a may obtain the object identifier corresponding to the transaction data 31c from the transaction attribute information of the transaction data 31c and determine, according to the object to which the transaction data 31c belongs, a security level of the transaction data 31c. If the security level of the transaction data 31c is greater than or equal to the security level threshold, it is determined that the transaction data 31c is the on-chain data. If the security level of the transaction data 31c is less than the security level threshold, it is determined that the transaction data 31c is the off-chain data. Particularly, other node devices in the blockchain network a may further determine, according to the foregoing manner, whether the transaction data 31c is the off-chain data. If most (for example, 51%) node devices in the blockchain network determine that the transaction data 31c is the on-chain data, operation S32 is performed. If most (for example, 51%) node devices in the blockchain network determine that the transaction data 31c is the off-chain data, operation S33 is performed. Similarly, the off-chain data storage rule may further be stored in the business function. That is, whether the transaction data 31c is the off-chain data is determined according to the off-chain storage rule of the business function.

S32: If the transaction data 31c is the on-chain data, the node device 21a reads the transaction data 31c from the blockchain 26b and returns the transaction data 31c to the terminal device 20a.

S33: If the transaction data 31c is the off-chain data, the node device 21a may invoke the business function in the cross-chain communication protocol and return an off-chain reading request to the terminal device 20a. The off-chain reading request may be generated according to device attribute information of the network device 23a and the transaction attribute information of the transaction data 31c.

S34: The terminal device 20a may read a transaction data packet from the network device 23a according to the off-chain reading request. Specifically, the network device 23a may query storage information associated with the transaction attribute information according to the transaction attribute information in the off-chain reading request, and read the transaction data packet from the blockchain 28b according to the storage information. The transaction data packet may include the transaction data 31c and signature information of an institution to which the network device 23a belongs. The signature information is configured for verifying whether the transaction data packet is transmitted by the network device 23a and whether the transaction data 31c in the transaction data packet has been tampered with. The signature information of the institution to which the network device 23a belongs is obtained by the network device 23a by signing the transaction data 31c using a private key of the institution to which the network device 23a belongs. The transaction data 31c is read by the network device 23a from the blockchain 28b in the node device 22a. Particularly, the signature information of the institution to which the network device 23a belongs may be obtained by the node device 21a by signing the transaction data 31c using a private key of the institution to which the node device 21a belongs in a process of storing the transaction data 31c. The node device 22a stores the transaction data packet including the transaction data 31c. The network device 23a reads the transaction data packet from the node device 22a and returns the transaction data packet to the terminal device 20a.

S35: The terminal device 20a forwards the transaction data packet to the node device 21a.

S36: When confirming that the transaction data 31c is valid, the node device 21a returns the transaction data 31c to the terminal device 20a. After receiving the transaction data packet, the node device 21a may invoke a data verification function in the cross-chain communication protocol to verify validity of the transaction data 31c in the transaction data packet, for example, performing a hash operation on the transaction data 31c, to obtain a hash value of the transaction data 31c, perform signature verification on signature information of an institution to which the network device belongs using a public key of the institution to which the network device belongs, to obtain signature verification data, and determine that verification of the transaction data 31c succeeds if the signature verification data matches the hash value of the transaction data 31c. Further, when it is determined that the transaction data 31c is valid, the transaction data 31c is transmitted to the terminal device 20a.

In summary, based on the foregoing operation S30 to operation S36, cross-chain storage of the transaction data may be realized, thereby avoiding storing all transaction data to the same blockchain network and reducing the data storage pressure of the blockchain network. Meanwhile, the terminal device does not need to sense interaction details of storing the transaction data to an off-chain node device, that is, the data processing application in the terminal device does not need to be improved, so as to adapt to the off-chain data storage, thereby reducing the development cost. Based on the foregoing operation S30 to operation S36, the off-chain data is securely read through a set of generalized cross-chain communication protocols, data for verification does not need to be separately stored on the chain for each piece of transaction data, and additional credit assumptions are not needed so that the applicability scope of this application is improved, and generalized reading of the off-chain data may be realized. Meanwhile, through the cross-chain communication protocol, a node device in one blockchain network reads data from another blockchain network, and interoperability between different blockchain networks is realized, that is, intercommunication of messages between different blockchain networks is realized.

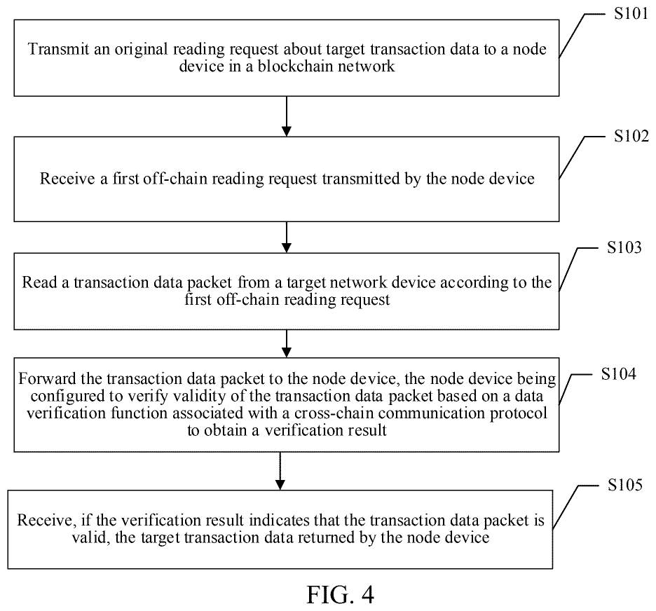

Further, FIG. 4 is a schematic flowchart of a blockchain-based data processing method according to an embodiment of this application. As shown in FIG. 4, the method may be performed by the terminal device in FIG. 1. The blockchain-based data processing method may include the following operation S101 to operation S105.

S101: Transmit an original reading request about target transaction data to a node device in a blockchain network, the original reading request carrying transaction attribute information of the target transaction data.

In this application, transaction data to be read by a terminal device is referred to as the target transaction data. The target transaction data is on-chain data or off-chain data of the blockchain network. The off-chain data of the blockchain network may be transaction data stored by the node device in the blockchain network to an external device. The on-chain data of the blockchain network may be transaction data stored by the node device in the blockchain network to a blockchain (i.e., a blockchain account book) in the blockchain network. The terminal device may generate the original reading request about the target transaction data and transmit the original reading request to any node device in the blockchain network. The terminal device does not sense whether the node device stores the target transaction data on-chain or off-chain, that is, the terminal device stores the target transaction data on-chain in the blockchain network by default. Therefore, the original reading request may be an on-chain reading request about the target transaction data. The original reading request may carry the transaction attribute information of the target transaction data. The transaction attribute information of the target transaction data may include a data volume of the target transaction data, an object identifier of an object (such as a user or an institution) to which the target transaction data belongs, a purpose of the target transaction data, and the like. The object identifier may include a public key or an account (such as a payment account) of the object in the blockchain network. The original reading request may further include a protocol address (i.e., a contract address) corresponding to the cross-chain communication protocol and a function identifier of a business function (the business function is configured for performing an operation related to the target transaction data, for example, reading the target transaction data). After receiving the original reading request, the node device may invoke the cross-chain communication protocol based on the protocol address and further invoke the business function in the cross-chain communication protocol through the function identifier. If the target transaction data is a balance of a payment account of a user, and the original reading request is to request to read the balance, the business function configured for reading the balance may be balanceOf, that is, the original reading request may carry a function identifier of balanceOf.

S102: Receive a first off-chain reading request transmitted by the node device, the first off-chain reading request being generated by the node device through the business function; the first off-chain reading request being generated according to the transaction attribute information and device attribute information of a target network device; the device attribute information being obtained by querying the cross-chain communication protocol by the node device when the node device determines, through the business function, that the target transaction data is off-chain data of the blockchain network; and the target network device being a device configured to read the off-chain data of the blockchain network.

In this application, after receiving the original reading request, the node device may invoke the business function in the cross-chain communication protocol through the original reading request and determine, based on the business function in the cross-chain communication protocol, whether the target transaction data is the off-chain data. For a specific determination process, reference may be made to operation S31 in the embodiment corresponding to FIG. 3, and details are not described again. When determining that the target transaction data is the off-chain data, the node device may query, based on the cross-chain communication protocol, the device attribute information of the target network device configured to read the off-chain data of the blockchain network, generate a first on-chain reading request according to the business function, the device attribute information, and the transaction attribute information, and transmit the first on-chain reading request to the terminal device.

The target network device may be an entry configured to read the off-chain data of the blockchain network, and there may be one or more target network devices. The first off-chain reading request may include extra data, an initial verification function and a request generation template in the cross-chain communication protocol, and a protocol address of the cross-chain communication protocol. The extra data and the initial verification function are configured for verifying the transaction data packet returned by the network device. The extra data may include at least one of a public key of an institution to which the network device belongs, a standard data volume or a standard data format of the target transaction data, and the like. The standard data volume refers to a data volume of the target transaction data when the target transaction data is not tampered with, and the standard data format may be a data format of the target transaction data when the target transaction data is not tampered with. The request generation template is configured for instructing how to generate the off-chain reading request adapted to the target network device. The request generation template may include the device attribute information of the target network device, for example, an IP address of the target network device.

In some embodiments, the original reading request may further carry a protocol address (which may be understood as a contract address) of a cross-chain communication protocol associated with the terminal device and the node device. The protocol address in the original reading request is obtained by the terminal device and is configured for indicating a cross-chain communication protocol that the terminal device expects to trigger. The first off-chain reading request carries the protocol address. After receiving the first off-chain reading request, the terminal device may compare the protocol address in the first off-chain reading request with the protocol address in the original reading request. If the protocol address in the first off-chain reading request is the same as the protocol address in the original reading request, it is determined that the first off-chain reading request is triggered by the cross-chain communication protocol indicated in the original reading request, and the terminal device may perform operation S103. If the protocol address in the first off-chain reading request is different from the protocol address in the original reading request, it is determined that the first off-chain reading request is not triggered by the cross-chain communication protocol indicated by the original reading request, and the terminal device may end this procedure. In this way, returning of error data to the terminal device may be avoided.

S103: Read a transaction data packet from the target network device according to the first off-chain reading request, the transaction data packet being read by the target network device from an external device associated with the blockchain network.

In this application, after receiving the first off-chain reading request, the terminal device may read the transaction data packet from the target network device according to the off-chain reading request. The transaction data packet may contain the target transaction data or may include encoded data obtained after the target transaction data is encoded (the encoded data may be decoded by the node device subsequently to restore the target transaction data). Certainly, even if the transaction data packet already contains the target transaction data, the transaction data packet still needs to be forwarded to the node device. This is because the node device needs to verify the validity of the target transaction data in the transaction data packet and return the target transaction data when verifying that the target transaction data is valid. In this case, the target transaction data obtained by the terminal device from the node device is valid and reliable. The transaction data packet may further include signature information of an institution to which the target network device belongs (the signature information may be provided to the node device for verification to ensure the validity of the target transaction data). The transaction data packet may be read by the network device from the external device associated with the blockchain network. The external device may be any node device in an associated blockchain network having an association relationship with the blockchain network, or may be a database device associated with the blockchain network. That is, the target transaction data may be stored on a blockchain in another blockchain network. In this way, interoperability between different blockchain networks may be realized.

The target network device is usually maintained by an institution to which the blockchain network belongs. Therefore, the node device in the blockchain network stores a public key and a private key of the institution to which the target network device belongs. Further, the signature information of the institution to which the target network device belongs may be obtained by the node device in the blockchain network by signing the target transaction data using the private key of the institution to which the network device belongs in a process of storing the target transaction data. That is, the external device stores the transaction data packet including the target transaction data and the signature information of the institution to which the target network device belongs. Alternatively, the signature information of the institution to which the target network device belongs may be obtained by signing the target transaction data using the private key of the institution to which the network device belongs after the target network device reads the target transaction data from the external device. That is, the external device stores the target transaction data.

In some embodiments, a specific process of reading the transaction data packet from the target network device according to the first off-chain reading request may be as follows. The terminal device may generate, according to the first off-chain reading request, a second off-chain reading request adapted to the target network device. The second off-chain reading request adapted to the target network device refers to an off-chain reading request that can be successfully parsed by the target network device. A request format of the second off-chain reading request is a request format indicated by the request generation template. The request format includes any one of a hyper text transfer protocol (HTTP), hypertext transfer protocol secure (HTTPS), or the like. The second off-chain reading request may be configured for instructing the target network device to read the target transaction data from the external device. The second off-chain reading request includes one or more of callback data, the protocol address corresponding to the cross-chain communication protocol, the device attribute information of the target network device, or the like. The callback data is configured for indicating an off-chain reading method required by the target network device to read the target transaction data (the off-chain reading method is an off-chain reading method function and may be configured for reading the target transaction data). Specifically, the target transaction data may be read from the external device through the off-chain reading method. The callback data is obtained by encoding the transaction attribute information and a method identifier of the off-chain reading method. The off-chain reading method may be a function configured for reading the off-chain data. Further, the terminal device may transmit the second off-chain reading request to the target network device, and the target network device is configured to generate a request response message according to the second off-chain reading request. The terminal device may receive the request response message returned by the target network device. For example, the terminal device determines, according to a state value of the request response message, whether the request response message is a response success message. For example, when the state value is 200, the terminal device determines that the request response message is the response success message. Alternatively, the request response message is queried to determine whether the transaction data packet is included. If the transaction data packet is included, it is determined that the request response message is the response success message, and the transaction data packet is obtained from the request response message. The terminal device reads the transaction data packet from the target network device through the first off-chain reading request so that interconnection and intercommunication between the terminal device and the target network device may be realized, and the efficiency of reading the transaction data packet is improved.

The request response message may include a response success message or a response failure message. The response success message is configured for indicating that the target network device successfully reads the transaction data packet from the external device, that is, the response success message includes the transaction data packet. The response failure message is configured for indicating that the target network device cannot read the transaction data packet from the external device, and the response failure message may include a state value. An example in which the request format indicated by the request generation template is the HTTPS is used. If the state value is within [400, 499], the second off-chain reading request is invalid. If the state value is 404, the target network device does not support the contract address in the second off-chain reading request (for example, the contract address is incorrect, that is, the contract address is different from the protocol address of the cross-chain communication protocol). If the state value is 400, the data format of the callback data is invalid, that is, the target network device cannot parse the callback data. If the state value is within [500, 599], there is an abnormality in the target network device. If the state value is 500, there is an error in the target network device.

In some embodiments, the first off-chain reading request includes a protocol address of the cross-chain communication protocol, a request generation template in the cross-chain communication protocol, and callback data. The request generation template is adapted to the target network device. The callback data contains an off-chain reading method configured for instructing the target network device to read the target transaction data, and the off-chain reading method is locally stored in the target network device. In some embodiments, an example in which the request format indicated by the request generation template is the HTTPS is used. The foregoing specific process of generating the second off-chain reading request adapted to the target network device according to the first off-chain reading request may be as follows. If the request generation template includes a data field and a sender field, in the request generation template, the sender field is replaced with the protocol address, and the data field is replaced with the callback data to obtain an obtaining request about the target transaction data. The obtaining request may alternatively be referred to as a GET request, and a request format of the GET request is a json format. Further, the obtaining request is determined as the second off-chain reading request adapted to the target network device. The second off-chain reading request adapted to the target network device is generated through the request generation template in the cross-chain communication protocol. In this way, a success rate of parsing the second off-chain reading request by the target network device may be improved.

The target network device may include multiple cross-chain communication protocols. Different cross-chain communication protocols have different functions and may be associated with different blockchain networks. One cross-chain communication protocol is associated with one or more methods (which may alternatively be referred to as functions or method interfaces). Different methods are configured for implementing different functions. For example, the cross-chain communication protocol may include a data update function and the foregoing business function. The foregoing data update function is configured for updating the off-chain data.

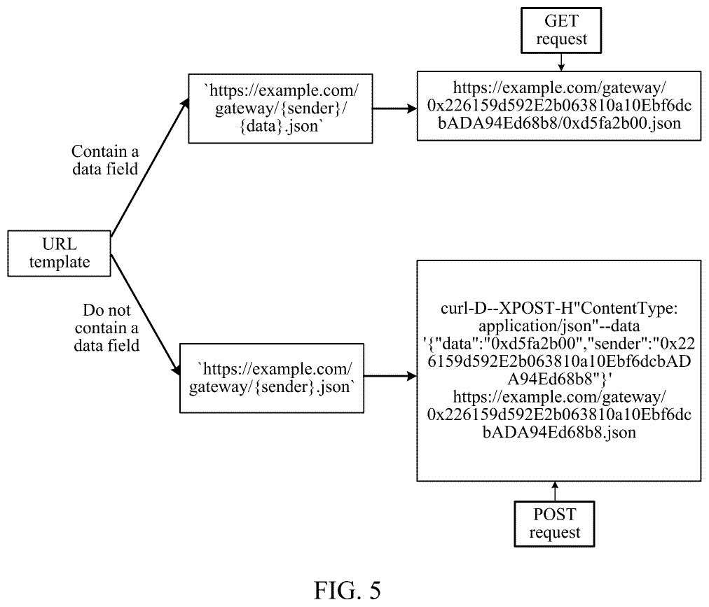

For example, as shown in FIG. 5, the request generation template may alternatively be referred to as a URL template. When the request generation template is: ‘https://example.com/gateway/{sender}/{data}.json’, the request generation template includes a data field and a sender field, i.e., {data}, https://example.com/gateway/, representing an IP address of the target network device. {sender} represents the sender field and is configured for carrying the protocol address of the cross-chain communication protocol, and {data} represents the data field and is configured for carrying the callback data. The second off-chain reading request generated based on the first off-chain reading request is: https://example.com/gateway/0x226159d592E2b063810a10Ebf6dcbADA94Ed68b8/0xd5fa2b00.js on, where https://example.com/gateway represents the IP address of the target network device, 0x226159d592E2b063810a10Ebf6dcbADA94Ed68b8 represents the protocol address of the cross-chain communication protocol, and 0xd5fa2b00 represents the callback data. The callback data is obtained by encoding the off-chain reading method configured for reading the target transaction data and a parameter (for example, an account of an object to which the target transaction data belongs) required for reading the target transaction data.

In some embodiments, an example in which the request format indicated by the request generation template is the HTTPS is used. The specific process of generating the second off-chain reading request adapted to the target network device according to the first off-chain reading request may be as follows. If the request generation template does not include the data field but contains the sender field, the terminal device may generate a processing request and use the processing request as the second off-chain reading request. The processing request may be referred to as a POST request, and content type information configured for declaring a format of a request body may be added to a request header. That is, content type information Content-Type of the request header of the processing request is to be application/json (the content type information is configured for declaring that the request body is in a json format). The request body is in the json format and includes the sender field {sender} and the data field {data} that are both of a string type and are encoded in hexadecimal using an 0x prefix. Specifically, if the request generation template includes the sender field but does not include the data field, the content type information configured for declaring the format of the request body is added to the request header. The data field and the sender field are added to an initial request body, the callback data is used as a field value of the data field in the initial request body, and the protocol address is used as a field value of the sender field in the initial request body to obtain the request body. In the request generation template, the sender field is replaced with the protocol address, a processing request about the target transaction data is generated according to a replaced request generation template, the request header, and the request body, and the processing request is determined as the second off-chain reading request adapted to the target network device. The second off-chain reading request adapted to the target network device is generated through the request generation template in the cross-chain communication protocol. In this way, a success rate of parsing the second off-chain reading request by the target network device may be improved.

For example, as shown in FIG. 5, when the request generation template is: ‘https://example.com/gateway/{sender}.json’ (i.e., a URL template), the request generation template does not include the data field (i.e., {data}) but includes the sender field (i.e., {sender}). The second off-chain reading request generated based on the first off-chain reading request is shown in Table 2. curl-D-XPOSTH “Content-Type:application/json”—data in Table 2 represents the request header. {“data”:“0xd5fa2b00”,“sender”:“0x226159d592E2b063810a10Ebf6dcbADA94Ed68b8”} represents the request body, “0xd5fa2b00” represents the callback data, and “0x226159d592E2b063810a10Ebf6dcbADA94Ed68b8” represents the protocol address. https://example.com/gateway/0x226159d592E2b063810a10Ebf6dcbADA94Ed68b8.json in Table 2 represents a request URL (i.e., the replaced request generation template), https://example.com/gateway/represents the IP address of the target network device, and 0x226159d592E2b063810a10Ebf6dcbADA94Ed68b8 represents the protocol address.

TABLE 2
curl-D--XPOST-H“Content-Type:application/json”--data
‘{“data”:“0xd5fa2b00”,“sender”:“0x226159d592E2b063810a10Ebf6dcbADA94Ed68b8”}’
https://example.com/gateway/0x226159d592E2b063810a10Ebf6dcbADA94Ed68b8.json

In some embodiments, the first off-chain reading request carries request generation templates corresponding to N candidate network devices, the request generation templates corresponding to the N candidate network devices are arranged in the first off-chain reading request according to a descending order of credibilities of the candidate network devices, and N is an integer greater than 1. The credibility of the candidate network device may be determined according to one or more of transaction data reading efficiency, network stability, security, or the like of the candidate network device. The terminal device may obtain sorting sequence numbers of N request generation templates in the first off-chain reading request, obtain a candidate network device i corresponding to a request generation template having a smallest sorting sequence number, and determine the candidate network device i as the target network device configured to read the off-chain data of the blockchain network. That is, when there are a plurality of candidate network devices, the terminal device may preferentially select a candidate network device with high credibility as the target network device for reading the transaction data packet. In this way, a success rate of reading the transaction data packet may be improved, and the efficiency and security of reading the transaction data packet may be improved.

In some embodiments, if the request response message is a response failure message and a state value carried by the request response message is within a first threshold range, the first threshold range indicates that the target network device fails to parse the data in the second off-chain reading request, that is, the second off-chain reading request is not adapted to the target network device. In this case, if the target network device is reselected for retrying, data parsing still fails. Therefore, the terminal device may suspend transmitting the second off-chain reading request to remaining network devices, that is, the terminal device does not need to perform retrying again and suspends obtaining the target transaction data. The remaining network devices are network devices in the N candidate network devices except the candidate network device i. If the request response message is the response failure message and the state value carried by the request response message is within a second threshold range, the second threshold range indicates that the there is an abnormality in the target network device, and the terminal device may re-determine, according to the sorting sequence numbers of the remaining network devices, the target network device configured to read the off-chain data of the blockchain network from the remaining network device, and retransmit the second off-chain reading request to a new target network device, i.e., selecting a different candidate network device for retrying. Whether to perform retrying is adaptively selected through the state value to obtain the transaction data packet. In this way, resource waste caused by invalid retrying may be avoided, and the success rate of reading the transaction data packet is improved through effective retrying.

The first threshold range and the second threshold range may be preset, for example, data in the cross-chain communication protocol. The first threshold range may be [400, 499], and the second threshold range may be [500, 599].

In a case that the response of the target network device succeeds, a message format of a request response message returned by the target network device when the second off-chain reading request is the GET request is the same as a message format of a request response message returned when the second off-chain reading request is the POST request. For example, when the target network device responds successfully, Content-Type (content type) of a response header in a returned request response message is to be application/json. The response body is in a json format and contains a data field data of a character type string as a response result (i.e., the transaction data packet). The response result is obtained by hexadecimal encoding, and 0x is used as a prefix. For example, the request response message may be shown in Table 3. 200 in Table 3 represents a state value and reflects that the request response message is a response success message. 8-bit universal character set/unicode transformation format (UTF-8) is a variable-length character encoding for Unicode and reflects that character encoding of a message header of the request response message is UTF-8. “0xdeadbeefdecafbad” represents the transaction data packet, i.e., obtained by encoding the target transaction data based on the UTF-8.

TABLE 3

```
HTTP/2 200
  content-type: application/json; charset=UTF-8
  ...
    {“data”: “0xdeadbeefdecafbad”}
```

In a case that the response of the target network device fails, the message format of the request response message returned by the target network device when the second off-chain reading request is the GET request is the same as the message format of the request response message returned when the second off-chain reading request is the POST request. The response header of the request response message includes the state value, and a content type (message format) is application/json. The response body is to be in the json format and contain a message field message of a character string type. A value of the message field is a readable error message and is configured for reflecting a reason why the response fails. For example, the request response message may be shown in Table 4. 404 in Table 4 represents a state value and reflects that the request response message is a response failure message. “Gateway address not supported.” represents a reason why the response of the target network device fails, that is, the target network device does not support the cross-chain communication protocol indicated by the protocol address.

TABLE 4

```
  HTTP/2 404
  content-type: application/json; charset=UTF-8
  ...
  {“message”: “Gateway address not supported.”}
}
```

In some embodiments, the terminal device may count the number of transmitting times of the second off-chain reading request (i.e., the number of times that the second off-chain reading request has been transmitted) and suspend performing, if the number of transmitting times is greater than a times threshold and the request response message returned by the target network device is the response failure message, the operation of re-determining the target network device configured to read the off-chain data of the blockchain network from the remaining network devices according to sorting sequence numbers of the remaining network devices. The times threshold herein may be preset in the cross-chain communication protocol, for example, it may be four. In this way, network congestion caused by unlimited retries may be avoided.

S104: Forward the transaction data packet to the node device, the node device being configured to verify validity of the transaction data packet based on a data verification function associated with the cross-chain communication protocol to obtain a verification result.

In this application, after obtaining the transaction data packet, the terminal device may forward the transaction data packet to the node device. The node device may be configured to verify the validity of the target transaction data or encoded data (i.e., data obtained after the target transaction data is encoded) in the transaction data packet based on the data verification function associated with the cross-chain communication protocol to obtain the verification result. The data verification function may be obtained by the terminal device by adding a public key of an institution to which the target network device belongs as well as the transaction data packet to an initial verification function. The data verification function is configured for indicating how to verify the validity of the transaction data packet. For example, the validity of the transaction data packet is verified by verifying signature information of the institution to which the target network device belongs. Alternatively, the validity of the transaction data packet is verified by verifying a data format, a data volume, or the like of the target transaction data.

In some embodiments, the first off-chain reading request carries the initial verification function in the cross-chain communication protocol and extra data configured for verifying the target transaction data. For example, the extra data may be one or more of the public key of the institution to which the target network device belongs, a standard data format or a data volume of the target transaction data, or the like. A specific process of forwarding the transaction data packet to the node device may be as follows. The terminal device may add the transaction data packet and the public key to the initial verification function to obtain the data verification function (which actually may be understood as a function identifier and a parameter of the data verification function, and the parameter includes the transaction data packet and the public key) associated with the cross-chain communication protocol. Then, the terminal device may transmit the data verification function to the node device (which may alternatively be understood that the function identifier and the parameter of the data verification function are transmitted to the node device so that the node device may invoke the data verification function (which is specifically a function having verification function code in the node device) based on the function identifier and verify the transaction data packet through the data verification function and the parameter). The node device is further configured to verify the validity of the transaction data packet in the data verification function based on a data verification rule in the data verification function and the extra data to obtain the verification result. After receiving the first off-chain reading request, the terminal device only needs to add the extra data in the first off-chain reading request to the initial verification function without reservation and modification, that is, the terminal device is non-transparent to the extra data. That is, the terminal device does not need to sense details of verification performed by the node device on the transaction data packet. In other words, the data processing application in the terminal device does not need to be modified to adapt to a verification process of the off-chain data, thereby reducing the development cost.

S105: Receive, if the verification result indicates that the transaction data packet is valid, the target transaction data returned by the node device, the target transaction data returned by the node device being obtained by parsing the transaction data packet by the node device.

In this application, when the verification result indicates that the transaction data packet is valid, the node device may transmit the target transaction data to the terminal device. When the verification result indicates that the target transaction data is invalid, the node device may return a read failure message to the terminal device. The read failure message is configured for indicating that the target transaction data is invalid. When verifying that the transaction data packet is valid, the node device may parse the transaction data packet to obtain the target transaction data, and then return the target transaction data to the terminal device. If the transaction data packet directly contains the target transaction data, the transaction data packet is decapsulated to obtain the target transaction data. If the transaction data packet contains encoded data corresponding to the target transaction data, after the transaction data packet is decapsulated, the encoded data further needs to be decoded to obtain the target transaction data. In this way, invalid transaction data may be prevented from being transmitted to the terminal device, resource waste may be avoided, and the off-chain reading security of the transaction data may be improved.

In this application, the node device in the blockchain network pre-generates a set of generalized cross-chain communication protocols. The cross-chain communication protocol is configured for indicating how to securely read the off-chain data through the blockchain network. For example, the cross-chain communication protocol includes the business function configured for issuing an off-chain reading request and the data verification function configured for verifying the off-chain data. The off-chain data can be securely read through the cross-chain communication protocol to ensure the security of the read transaction data, and on-chain and off-chain interoperability can be realized. Specifically, when the terminal device needs to read the target transaction data, the terminal device may transmit the original reading request about the target transaction data to the node device in the blockchain network. The original reading request carries the transaction attribute information of the target transaction data. After receiving the original reading request, the node device may determine, by invoking the business function in the cross-chain communication protocol, whether the target transaction data is the off-chain data of the blockchain network. If it is determined that the target transaction data is the off-chain data of the blockchain network, the foregoing cross-chain communication protocol may be queried for the device attribute information of the target network device configured to read the off-chain data of the blockchain network. Further, the node device generates the first off-chain reading request according to the device attribute information and the transaction attribute information and transmits the first off-chain reading request to the terminal device. The first off-chain reading request is configured for instructing the target network device to return the transaction data packet to the terminal device. After receiving the first off-chain reading request, the terminal device reads the transaction data packet from the target network device and forwards the transaction data packet to the node device. The node device invokes the data verification function to verify the validity of the transaction data packet. When the transaction data packet is valid, the node device may parse the transaction data packet to obtain the target transaction data, and transmit the target transaction data obtained through parsing to the terminal device. In this way, the off-chain data may be securely read on the chain, and the validity of the off-chain data (i.e., the target transaction data) can be ensured. Meanwhile, the off-chain data is read through a set of generalized cross-chain communication protocols, data for verification does not need to be separately stored on the chain for each piece of transaction data, interaction details of storing the transaction data to the external device do not need to be sensed by the terminal device, and additional credit assumptions are not needed so that the applicability scope of this application is improved, and generalized reading of the off-chain data may be realized. In addition, the target transaction data is read by the target network device from the external device associated with the blockchain network, and the validity of the target transaction data may be ensured. Therefore, off-chain storage of the target transaction data is possible. In this way, the data storage pressure of the blockchain network may be reduced, and the data storage cost may be reduced.

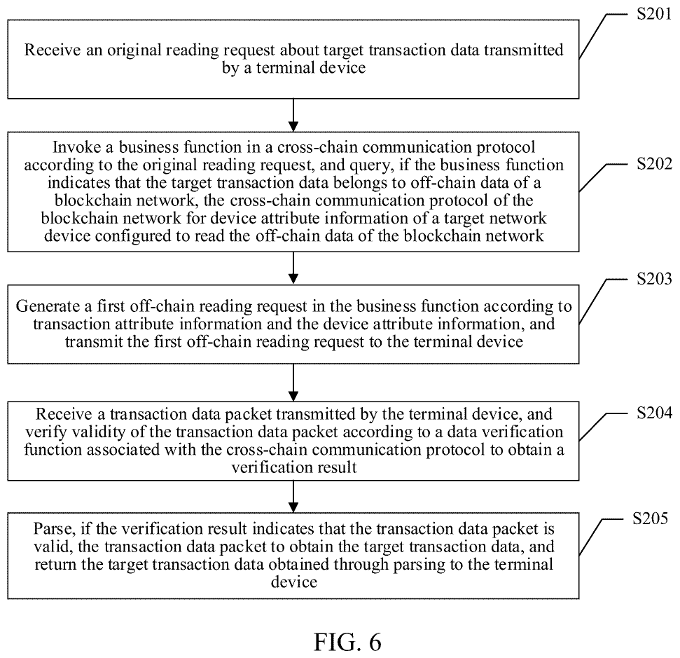

Further, FIG. 6 is a schematic flowchart of a blockchain-based data processing method according to an embodiment of this application. As shown in FIG. 6, the method may be performed by any node device in FIG. 1. The blockchain-based data processing method may include the following operation S201 to operation S205.

S201: Receive an original reading request about target transaction data transmitted by a terminal device, the original reading request carrying transaction attribute information of the target transaction data.

In this application, a node device in a blockchain network may receive the original reading request about the target transaction data transmitted by the terminal device. The original reading request carries the transaction attribute information of the target transaction data. After receiving the original reading request, the node device may invoke a cross-chain communication protocol (which may alternatively be referred to as a smart contract) in the blockchain network and further invoke a business function in the cross-chain communication protocol. The business function may verify whether the target transaction data is off-chain data of the blockchain network. When the target transaction data is the off-chain data of the blockchain network, operation S202 is performed. When the target transaction data is on-chain data of the blockchain network, the node device may read the target transaction data from the blockchain in the blockchain network, return the target transaction data to the terminal device, and end this procedure. For an implementation process of verifying whether the target transaction data is the on-chain data in the blockchain network, reference may be made to operation S31 in FIG. 3.

S202: Invoke a business function in a cross-chain communication protocol according to the original reading request, and query, if the business function indicates that the target transaction data is off-chain data of a blockchain network, the cross-chain communication protocol of the blockchain network for device attribute information of a target network device configured to read the off-chain data of the blockchain network.

In this application, the node device may invoke the business function in the cross-chain communication protocol according to the original reading request. The cross-chain communication protocol records the device attribute information of the target network device configured to read the off-chain data of the blockchain network. Therefore, if the target transaction data is the off-chain data of the blockchain network, the cross-chain communication protocol in the blockchain network is queried for the device attribute information of the target network device configured to read the off-chain data of the blockchain network.

In some embodiments, when there are a plurality of network devices configured to read the off-chain data, the node device may query the cross-chain communication protocol of the blockchain network for device attribute information corresponding to N candidate network devices configured to read the off-chain data of the blockchain network. The N candidate network devices include the target network device, and N is an integer greater than 1. The candidate network device refers to a network device configured to read the off-chain data in the blockchain network. The N candidate network devices may be distributed in different regions and may belong to the same institution or different institutions.

S203: Generate a first off-chain reading request in the business function according to the transaction attribute information and the device attribute information, and transmit the first off-chain reading request to the terminal device, the terminal device being configured to read a transaction data packet from the target network device according to the first off-chain reading request, and the transaction data packet being read by the target network device from an external device associated with a node device in the blockchain network.

In this application, the node device may generate the first off-chain reading request according to the transaction attribute information and the device attribute information, invoke the business function in the cross-chain communication protocol, and transmit the first off-chain reading request to the terminal device. After receiving the first off-chain reading request, the terminal device may read the transaction data packet from the target network device according to the first off-chain reading request. The transaction data packet may include signature information of an institution to which the target network device belongs. The transaction data packet may be read by the network device from the external device associated with the blockchain network.

In some embodiments, when there are a plurality of network devices configured to read the off-chain data, the node device may generate the first off-chain reading request according to the transaction attribute information and the device attribute information corresponding to the N candidate network devices. The device attribute information corresponding to the N candidate network devices is transmitted to the terminal device so that the terminal device autonomously selects an appropriate target network device to read the transaction data packet, thereby improving a success rate of reading the transaction data packet.

In some embodiments, the foregoing specific process of generating the first off-chain reading request according to the transaction attribute information and the device attribute information corresponding to the N candidate network devices may be as follows. The node device may obtain, from the device attribute information of the N candidate network devices, credibilities corresponding to the N candidate network devices and sort, according to a descending order of the credibilities corresponding to the N candidate network devices, the device attribute information corresponding to the N candidate network devices. The sorted device attribute information corresponding to the N candidate network devices is added to a device list. The first off-chain reading request is generated according to the device list and the transaction attribute information. The device attribute information corresponding to the N candidate network devices is sorted so that the terminal device preferentially selects a network device with high credibility as the target network device, thereby improving a success rate of reading the transaction data packet and improving the efficiency of reading the transaction data packet.

In some embodiments, a specific process of generating the first off-chain reading request according to the device list and the transaction attribute information may be as follows. Obtaining a protocol address (i.e., a contract address) of the cross-chain communication protocol according to a protocol identifier of the cross-chain communication protocol in the transaction attribute information and generating callback data according to content requested by the original reading request may be specifically: determining, based on the content (for example, the target transaction data) requested by the original reading request, an off-chain reading method that is to be used by the target network device (the off-chain reading method is configured for instructing the target network device to read the transaction data packet), and encoding the off-chain reading method to obtain the callback data. Subsequently, after obtaining the callback data, the target network device may obtain the off-chain reading method by decoding the callback data. The first off-chain reading request is generated in the business function according to the protocol address, the device list, a function identifier of the data verification function, extra data, and the callback data. The protocol address, the device list, and the callback data in the first off-chain reading request are configured for instructing the terminal device to obtain the transaction data packet through the target network device. The function identifier and the extra data in the first off-chain reading request are configured for instructing the terminal device to request to invoke the data verification function. The transaction data packet and the extra data are used as parameters in the data verification function. The data verification function is configured for verifying the validity of the transaction data packet through the extra data.

The first off-chain reading request may be an error response message (the error response message is configured for indicating that the requested target transaction data is the off-chain data, that is, the target transaction data cannot be directly found in the blockchain network, and therefore, the error response message is returned) returned by the node device to the terminal device for the original reading request. Content contained in the error response message is shown in Table 5. error OffchainLookup in Table 5 represents the error response message and may alternatively be referred to as an error query method. The error response message includes the following content. 1. A sender field sender: represents a protocol address of a cross-chain communication protocol triggering transmission of the error response message. 2. URLs: may alternatively be referred to as a device list. The device list includes request generation templates of N candidate network devices configured to read the off-chain data of the blockchain network, which are alternatively referred to as URL templates. The URL template may include two replacement parameters, {sender} and {data}. After receiving the error response message, the terminal device may replace {sender} in the URL template with a value (protocol address) of a sender parameter and encode in a hexadecimal format with a lowercase 0x prefix. {data} is replaced with a value of a callData parameter (i.e., callback data), a hexadecimal format with an 0x prefix is used, and a replaced URL template is referred to as a second off-chain reading request. Particularly, the URL template may include only {sender} and does not include {data}. 3. callData (callback data): is configured for indicating an off-chain reading method used when the target network device reads the transaction data packet, and may be specifically an encoded value of the off-chain reading method. The callback data may be non-transparent to the terminal device (that is, the terminal device does not need to understand the meaning of the encoded value), that is, the node device and the target network device may normalize the callback data according to needs, as long as they can encode and decode the off-chain reading method in a correct manner. 4. callbackFunction: specifies a callback method and may alternatively be referred to as an initial verification function. 5. extraData: is extra data needed by the initial verification function, and is reserved by the terminal device and provided to the initial verification function without modification. The value is non-transparent to the client. The initial verification function is configured for decoding and verifying data (for example, the target transaction data in the transaction data packet) returned by the target network device. The initial verification function has parameters (bytes response and bytes extraData), response is a response field, and extraData is an extra data field. When receiving the transaction data packet, the terminal device may use the transaction data packet as a field value of the response field and use the extra data in the first off-chain reading request as a field value of the extraData.

TABLE 5
error OffchainLookup(address sender, string[ ] urls, bytes callData, bytes4 callbackFunction, bytes
extraData)

S204: Receive the transaction data packet transmitted by the terminal device, and verify validity of the transaction data packet according to a data verification function associated with the cross-chain communication protocol to obtain a verification result.

In this application, after obtaining the transaction data packet, the terminal device may forward the transaction data packet to the node device. The node device may invoke the data verification function in the cross-chain communication protocol and verify the validity of the target transaction data in the transaction data packet through the data verification function to obtain the verification result. The data verification function may be obtained by the terminal device by adding a public key of an institution to which the target network device belongs as well as the transaction data packet to an initial verification function (the data verification function obtained by the terminal device is actually a function identifier and a parameter (the parameter includes the public key and the transaction data packet) corresponding to the data verification function, and specific function code of the data verification function is stored in the node device). The data verification function is configured for indicating how to verify the validity of the target transaction data in the transaction data packet. For example, the validity of the target transaction data is verified by verifying signature information of the institution to which the target network device belongs. Alternatively, the validity of the target transaction data is verified by verifying a data format, a data volume, or the like of the target transaction data. The verification result is configured for indicating whether the transaction data packet is valid or invalid. The transaction data packet being valid refers to at least one of the following: the target transaction data is not tampered with, or the target transaction data is returned by a legal target network device. The transaction data packet being invalid refers to at least one of the following: the target transaction data is tampered with, or the target transaction data is not returned by a legal target network device. After receiving the data verification function (actually, receiving the function identifier and the parameter corresponding to the data verification function), the node device may invoke, through the function identifier, the data verification function associated with the cross-chain communication protocol and verify the target transaction data through the data verification function and the parameter, which is conducive to ensuring the security of reading the off-chain data.

In some embodiments, the first off-chain reading request carries the initial verification function in the cross-chain communication protocol and the extra data configured for verifying the target transaction data. Operation S204 includes the following operations. The node device may receive the data verification function transmitted by the terminal device. The data verification function is obtained by adding the transaction data packet and the extra data to the initial verification function by the terminal device. The node device may verify the target transaction data in the data verification function according to the extra data and the data verification rule in the data verification function to obtain the verification result.

In some embodiments, the transaction data packet further includes signature information of an institution to which the target network device belongs. The data verification function includes the data verification rule and the public key of the institution to which the target network device belongs. That is, the extra data includes the public key of the institution to which the target network device belongs, and the data verification rule is configured for instructing to verify the signature information. A specific process of verifying the validity of the target transaction data in the transaction data packet according to the data verification function associated with the cross-chain communication protocol to obtain the verification result may be as follows. The node device may perform a hash operation on the target transaction data in the transaction data packet to obtain a hash value of the transaction data packet. Then, signature verification is performed on the signature information according to the public key of the institution to which the target network device belongs, to obtain signature verification data. That is, the signature information is decrypted according to the public key of the institution to which the target network device belongs, to obtain the signature verification data. If the similarity between the hash value of the transaction data packet and the signature verification data is less than or equal to a similarity threshold, it is determined that the hash value of the transaction data packet does not match the signature verification data, that is, the target transaction data is not returned by the target network device, or the target transaction data is tampered with, and a verification result indicating that the target transaction data is invalid is generated. If the similarity between the hash value of the transaction data packet and the signature verification data is greater than the similarity threshold, it is determined that the hash value of the transaction data packet matches the signature verification data, that is, the target transaction data is returned by the target network device, and the target transaction data is not tampered with, and a verification result indicating that the transaction data packet is valid is generated.

In some embodiments, the data verification function includes the data verification rule and the standard data format of the target transaction data. That is, the extra data includes the standard data format of the target transaction data, and the data verification rule is configured for instructing to verify the data format of the target transaction data. A specific process of verifying the validity of the target transaction data in the transaction data packet according to the data verification function associated with the cross-chain communication protocol to obtain the verification result may be as follows. If the data format of the target transaction data in the transaction data packet is not the standard data format, the returned target transaction data is tampered with or read incorrectly, and a verification result indicating that the target transaction data is invalid is generated. If the data format of the target transaction data in the transaction data packet is the standard data format, the returned target transaction data is not tampered with and is read correctly, and a verification result indicating that the transaction data packet is valid is generated.

In some embodiments, the data verification function includes the data verification rule and the standard data volume of the target transaction data. That is, the extra data includes the standard data volume of the target transaction data, and the data verification rule is configured for instructing to verify the data volume of the target transaction data. A specific process of verifying the validity of the target transaction data in the transaction data packet according to the data verification function associated with the cross-chain communication protocol to obtain the verification result may be as follows. If a difference between the data volume of the target transaction data in the transaction data packet and the standard data volume is greater than a difference threshold, the returned target transaction data is tampered with (or a part of data is lost) or read incorrectly, and a verification result indicating that the transaction data packet is invalid is generated. If the difference between the data volume of the target transaction data in the transaction data packet and the standard data volume is less than or equal to the difference threshold, the returned target transaction data is not tampered with and is read incorrectly, and a verification result indicating that the transaction data packet is valid is generated.

S205: Parse, if the verification result indicates that the transaction data packet is valid, the transaction data packet to obtain the target transaction data, and return the target transaction data obtained through parsing to the terminal device.

In this application, if the verification result indicates that the transaction data packet is valid, the node device may parse the transaction data packet. If the transaction data packet carries the target transaction data, the node device may obtain the target transaction data after decapsulating the transaction data packet, and return the target transaction data in the transaction data packet to the terminal device. If the transaction data packet carries encoded data obtained after the target transaction data is encoded, after decapsulating the transaction data packet to obtain the encoded data, the node device further needs to decode the encoded data to obtain the target transaction data, and returns the target transaction data in the transaction data packet to the terminal device. In this way, invalid transaction data may be prevented from being transmitted to the terminal device, resource waste may be avoided, and the off-chain reading security of the transaction data may be improved.

The blockchain network and the associated blockchain network may be blockchain networks that both satisfy an admission condition of the cross-chain communication protocol. The admission condition may include that the blockchain network has legality (for example, the node device in the blockchain network is a legal individual or legal institution), stability (for example, network stability or storage stability) of the blockchain network is greater than a stability threshold, a security level of the blockchain network is greater than a security level threshold, and the like.

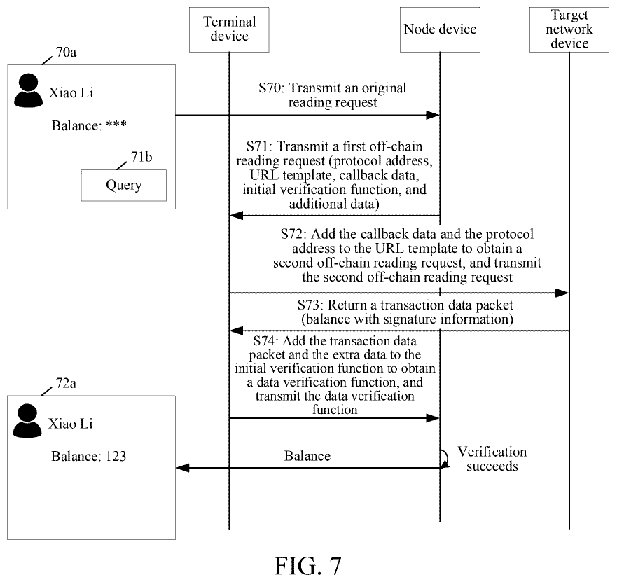

For example, as shown in Table 6, an example in which the terminal device needs to query a balance of an addr address is used for description, that is, the target transaction data that needs to be read is the balance of the addr address. The business function in the cross-chain communication protocol (i.e., smart contract) in this application is a functional function configured for querying for a balance of an account address. The business function may be represented as: function balanceOf(address addr) public view returns(uint balance). The business function is configured for instructing the node device to return the balance of the addr address when the node device verifies, based on the data verification function, that the queried balance is valid. The data verification function may be represented as: function balanceOfWithProof(bytes calldata response, bytes calldata extraData) public view returns(uint balance), which may alternatively be referred to as a balance verification function. In Table 6, OffchainLookup may be the first off-chain reading request returned by the business function (which may alternatively be referred to as an error response message, that is, the business function detects that the balance of the addr address is the off-chain data; therefore, the business function returns the error response message, and the error response message is configured for instructing the terminal device to obtain the transaction data packet containing the balance of the addr address from the target network device). Data contained in OffchainLookup may be described in detail with reference to FIG. 7 below.

```
TABLE 6
function balanceOf(address addr) public view returns(uint balance) {
  revert OffchainLookup(
    sender: protocol identifier,
    urls: [URL template of candidate network device],
    callData: specifying to invoke an “obtaining a balance with a signature” method + addr
address of the candidate network device,
    callbackFunction: balanceOfWithProof, initial verification function configured for
verifying balance,
    extraData: addr
  );
}
```

Specifically, as shown in FIG. 7, a process of querying a balance of a user through the business function includes the following operation S70 to operation S74.

S70: A terminal device transmits an original reading request to a node device.

When a user (Xiao Li) corresponding to the terminal device needs to query for a balance, that is, the balance may be referred to as target transaction data, the terminal device may display a balance query page 70a on a data processing application (such as a payment application). The balance query page 70a includes user information (such as a name, a nickname, and an account address) of the user corresponding to the terminal device and a query control 71b. The terminal device generates, in response to a trigger operation for the query control 71b, a query request about the balance of the user, uses the query request as the original reading request, and transmits the original reading request to the node device. The original query request carries the account address of the user corresponding to the terminal device, which may be referred to as an addr address. The original query request may further carry a protocol address of a cross-chain communication protocol and a function identifier of a business function. After receiving the original query request, the node device may invoke the cross-chain communication protocol based on the protocol address, and further invoke the business function in the cross-chain communication protocol based on the function identifier.

S71: The node device transmits a first off-chain reading request to the terminal device. After receiving the original reading request, the node device may invoke function balanceOf(address addr) public view returns(uint balance) to verify whether the balance is stored off-chain in the blockchain. If it is determined that the balance is stored off-chain in the blockchain, that is, the balance is off-chain data of a blockchain network, the node device may return the first off-chain reading request to the terminal device. The first off-chain reading request may be OffchainLookup shown in Table 6. As shown in Table 6, the first off-chain reading request carries a protocol address (a field value of a sender field), a URL template, callback data (callData), an initial verification function, and extra data (extraData). The initial verification function is a field value of a callback digit field callbackFunction. The initial verification function is a function for verifying the validity of the balance and may alternatively be referred to as balanceOfWithProof The extra data includes an addr address of a user corresponding to the terminal device.

S72: The terminal device adds the protocol address and the callback data to the URL template to obtain a second off-chain reading request, and transmits the second off-chain reading request to the target network device. After receiving the first off-chain reading request, the terminal device may select a candidate network device from urls as the target network device, replace a sender field in the URL template corresponding to the target network device with the protocol address, replace a data field in the URL template corresponding to the target network device with callData to obtain the second off-chain reading request, and transmit the second off-chain reading request to the target network device.

S73: The target network device returns a transaction data packet (balance with signature information) to the terminal device, obtains the balance (which may alternatively be referred to as the transaction data packet) with signature information of the addr address after receiving the second off-chain reading request, and returns the balance with signature information to the terminal device.

S74: The terminal device may add the transaction data packet and the extra data to the initial verification function to obtain a data verification function, and transmit the data verification function to the node device. The terminal device may add the balance with a signature and the extraData to the initial verification function to obtain a balance verification function (i.e., data verification function). The balance verification function is transmitted to the node device. The node device executes the balance verification function to decode and verify the balance with a signature and the extraData, and returns the balance to the terminal device when verification succeeds. The terminal device may display, in a query result interface 72a, the balance (i.e., target transaction data) returned by the node device. For example, the balance is 123.

According to the balance with the signature information herein, the signature information may be a signature of an institution to which the target network device belongs. The node device may query a blockchain for a public key of the institution to which the target network device belongs according to the addr address, verify the signature according to the public key, and if the signature verification succeeds, determine that the balance verification succeeds. Alternatively, the signature information may be a signature of a user corresponding to the terminal device, and the addr address may be a public key of the user. The node device may verify the signature according to the public key of the user, and if the signature verification succeeds, determine that the balance verification succeeds. For a specific verification process, reference may be made to operation S204.

In this application, the node device in the blockchain network pre-generates a set of generalized cross-chain communication protocols. The cross-chain communication protocol is configured for indicating how to securely read the off-chain data through the blockchain network. For example, the cross-chain communication protocol includes the business function configured for issuing an off-chain reading request and the data verification function configured for verifying the off-chain data. The off-chain data can be securely read through the cross-chain communication protocol to ensure the security of the read transaction data, and on-chain and off-chain interoperability can be realized. Specifically, when the terminal device needs to read the target transaction data, the terminal device may transmit the original reading request about the target transaction data to the node device in the blockchain network. The original reading request carries the transaction attribute information of the target transaction data. After receiving the original reading request, the node device may determine, by invoking the business function in the cross-chain communication protocol, whether the target transaction data is the off-chain data of the blockchain network. If it is determined that the target transaction data is the off-chain data of the blockchain network, the foregoing cross-chain communication protocol may be queried for the device attribute information of the target network device configured to read the off-chain data of the blockchain network. Further, the node device generates the first off-chain reading request according to the device attribute information and the transaction attribute information and transmits the first off-chain reading request to the terminal device. The first off-chain reading request is configured for instructing the target network device to return the transaction data packet to the terminal device. After receiving the first off-chain reading request, the terminal device reads the transaction data packet from the target network device and forwards the transaction data packet to the node device. The node device invokes the data verification function to verify the validity of the transaction data packet. When the transaction data packet is valid, the node device may parse the transaction data packet to obtain the target transaction data, and transmit the target transaction data obtained through parsing to the terminal device. In this way, the off-chain data may be securely read on the chain, and the validity of the off-chain data (i.e., the target transaction data) can be ensured. Meanwhile, the off-chain data is read through a set of generalized cross-chain communication protocols, data for verification does not need to be separately stored on the chain for each piece of transaction data, interaction details of storing the transaction data to the external device do not need to be sensed by the terminal device, and additional credit assumptions are not needed so that the applicability scope of this application is improved, and generalized reading of the off-chain data may be realized. In addition, the target transaction data is read by the target network device from the external device associated with the blockchain network, and the validity of the target transaction data may be ensured. Therefore, off-chain storage of the target transaction data is possible. In this way, the data storage pressure of the blockchain network may be reduced, and the data storage cost may be reduced.

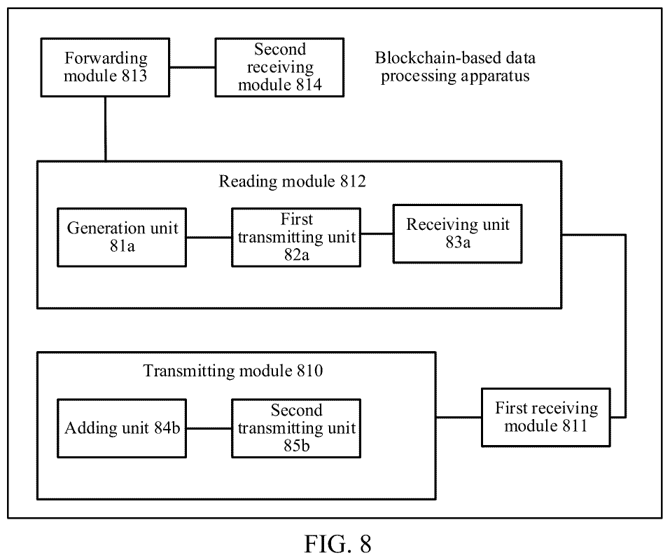

FIG. 8 is a schematic structural diagram of a blockchain-based data processing apparatus according to an embodiment of this application. The blockchain-based data processing apparatus may be a computer program (including program code) running in a terminal device. For example, the blockchain-based data processing apparatus is application software. The apparatus may be configured to perform the corresponding operations in the methods provided in the embodiments of this application. As shown in FIG. 8, the blockchain-based data processing apparatus may include:
a transmitting module 810 configured to transmit an original reading request about target transaction data to a node device in a blockchain network to cause the node device to invoke a business function in a cross-chain communication protocol according to the original reading request, the original reading request carrying transaction attribute information of the target transaction data;
a first receiving module 811 configured to receive a first off-chain reading request transmitted by the node device, the first off-chain reading request being generated by the node device through the business function; the first off-chain reading request being generated according to the transaction attribute information and device attribute information of a target network device; the device attribute information being obtained by querying the cross-chain communication protocol by the node device when the node device determines, through the business function, that the target transaction data is off-chain data of the blockchain network; and the target network device being a device configured to read the off-chain data of the blockchain network;
a reading module 812 configured to read a transaction data packet from the target network device according to the first off-chain reading request, the transaction data packet being read by the target network device from an external device associated with the blockchain network;
a forwarding module 813 configured to forward the transaction data packet to the node device, the node device being configured to verify validity of the transaction data packet based on a data verification function associated with the cross-chain communication protocol to obtain a verification result; and
a second receiving module 814 configured to receive, if the verification result indicates that the transaction data packet is valid, the target transaction data returned by the node device, the target transaction data returned by the node device being obtained by parsing the transaction data packet by the node device.

In some embodiments, the reading module 812 may include a generation unit 81a, a first transmitting unit 82a, and a receiving unit 83a.

The generation unit 81a is configured to generate a second off-chain reading request adapted to the target network device according to the first off-chain reading request.

The first transmitting unit 82a is configured to transmit the second off-chain reading request to the target network device, the target network device being configured to generate a request response message according to the second off-chain reading request.

The receiving unit 83a is configured to receive the request response message returned by the target network device, and obtain, if the request response message is a response success message, the transaction data packet from the request response message.

In some embodiments, the first off-chain reading request includes a protocol address of the cross-chain communication protocol, a request generation template in the cross-chain communication protocol, and callback data. The request generation template is adapted to the target network device. The protocol address and the callback data are jointly configured to instruct the target network device to read the target transaction data from the external device.

In some embodiments, the generation unit 81a is specifically configured to replace, in the request generation template, if the request generation template includes a data field and a sender field, the sender field with the protocol address, and replace the data field with the callback data to obtain an obtaining request about the target transaction data, and determine the obtaining request as the second off-chain reading request adapted to the target network device.

Alternatively, the generation unit 81a is specifically configured to add, if the request generation template includes a sender field and does not contain a data field, content type information configured for declaring a format of a request body to a request header; add the data field and the sender field to an initial request body, use the callback data as a field value of the data field in the initial request body, and use the protocol address as a field value of the sender field in the initial request body to obtain the request body; and replace, in the request generation template, the sender field with the protocol address, generate a processing request about the target transaction data according to a replaced request generation template, the request header, and the request body, and determine the processing request as the second off-chain reading request adapted to the target network device.

In some embodiments, the first off-chain reading request includes request generation templates corresponding to N candidate network devices, the request generation templates corresponding to the N candidate network devices are arranged in a device list of the first off-chain reading request according to a descending order of credibilities of the candidate network devices, and N is an integer greater than 1.

The generation unit 81a is further configured to obtain sorting sequence numbers of N request generation templates in the first off-chain reading request, and obtain a candidate network device i corresponding to a request generation template having a smallest sorting sequence number; and determine the candidate network device i as the target network device configured to read the off-chain data of the blockchain network.

In some embodiments, the transmitting module 810 is further configured to suspend transmitting the second off-chain reading request to remaining network devices if the request response message is a response failure message and a state value carried by the request response message is within a first threshold range, the remaining network devices being network devices in the N candidate network devices except the candidate network device i; and re-determine, if the request response message is the response failure message and the state value carried by the request response message is within a second threshold range, the target network device configured to read the off-chain data of the blockchain network from the remaining network devices according to sorting sequence numbers of the remaining network devices, and re-transmit the second off-chain reading request to a determined target network device.

In some embodiments, the transmitting module 810 is further configured to count the number of transmitting times of the second off-chain reading request; and suspending performing, if the number of transmitting times is greater than a times threshold and the request response message returned by the target network device is the response failure message, the operation of re-determining the target network device configured to read the off-chain data of the blockchain network from the remaining network devices according to sorting sequence numbers of the remaining network devices.

In some embodiments, the first off-chain reading request includes an initial verification function in the cross-chain communication protocol and extra data configured for verifying the transaction data packet. The transmitting module 810 may include an adding unit 84b and a second transmitting unit 85b.

The adding unit 84b is configured to add the transaction data packet and the extra data to the initial verification function to obtain the data verification function associated with the cross-chain communication protocol.

The second transmitting unit 85b is configured to transmit the data verification function to the node device. The node device is further configured to verify the validity of the target transaction data contained in the transaction data packet in the data verification function based on a data verification rule in the data verification function and the extra data to obtain a verification result.

In this application, the node device in the blockchain network pre-generates a set of generalized cross-chain communication protocols. The cross-chain communication protocol is configured for indicating how to securely read the off-chain data through the blockchain network. For example, the cross-chain communication protocol includes the business function configured for issuing the first off-chain reading request and the data verification function configured for verifying the off-chain data. The off-chain data can be securely read through the cross-chain communication protocol to ensure the security of the read transaction data, and on-chain and off-chain interoperability can be realized.

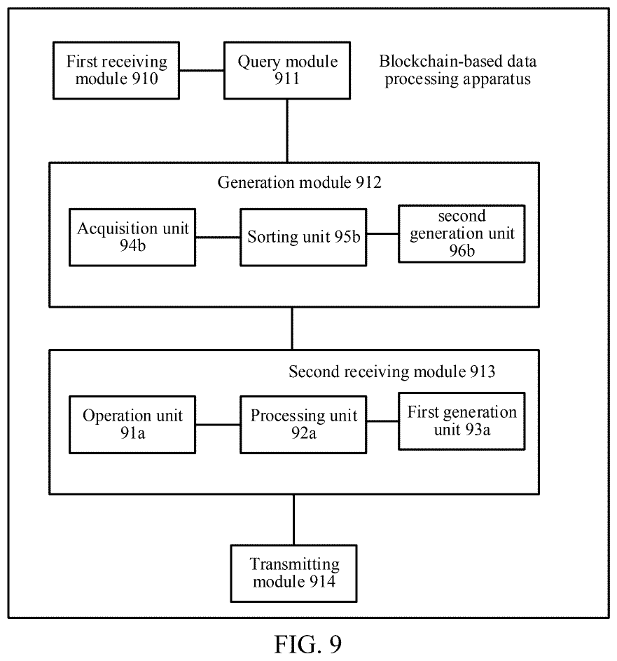

FIG. 9 is a schematic structural diagram of a blockchain-based data processing apparatus according to an embodiment of this application. The blockchain-based data processing apparatus may be a computer program (including program code) running in a network device. For example, the blockchain-based data processing apparatus is application software. The apparatus may be configured to perform the corresponding operations in the methods provided in the embodiments of this application. As shown in FIG. 9, the blockchain-based data processing apparatus may include:
a first receiving module 910 configured to receive an original reading request about target transaction data transmitted by a terminal device, the original reading request carrying transaction attribute information of the target transaction data;
a query module 911 configured to invoke a business function in a cross-chain communication protocol according to the original reading request, and query, if the business function indicates that the target transaction data is off-chain data of a blockchain network, the cross-chain communication protocol of the blockchain network for device attribute information of a target network device configured to read the off-chain data of the blockchain network;
a generation module 912 configured to generate a first off-chain reading request in the business function according to the transaction attribute information and the device attribute information, and transmit the first off-chain reading request to the terminal device, the terminal device being configured to read a transaction data packet from the target network device according to the first off-chain reading request, and the transaction data packet being read by the target network device from an external device associated with a node device in the blockchain network;
a second receiving module 913 configured to receive the transaction data packet transmitted by the terminal device, and verify validity of the transaction data packet according to a data verification function associated with the cross-chain communication protocol to obtain a verification result; and
a transmitting module 914 configured to parse, if the verification result indicates that the transaction data packet is valid, the transaction data packet to obtain the target transaction data, and return the target transaction data obtained through parsing to the terminal device.

In some embodiments, the transaction data packet further includes signature information of an institution to which the target network device belongs. The data verification function includes a data verification rule and a public key of the institution to which the target network device belongs, and the data verification rule is configured for instructing to verify the signature information.

The second receiving module 913 may include an operation unit 91a, a processing unit 92a, and a first generation unit 93a.

The operation unit 91a is configured to perform a hash operation on the target transaction data in the transaction data packet to obtain a hash value of the transaction data packet.

The processing unit 92a is configured to perform signature verification on the signature information according to the public key of the institution to which the target network device belongs, to obtain signature verification data.

The first generation unit 93a is configured to generate, if the hash value of the transaction data packet matches the signature verification data, the verification result indicating that the transaction data packet is valid.

In some embodiments, the query module 911 is specifically configured to query the cross-chain communication protocol of the blockchain network for device attribute information corresponding to N candidate network devices configured to read the off-chain data of the blockchain network, the N candidate network devices including the target network device, and N being an integer greater than 1.

In addition, the generation module 912 is specifically configured to generate the first off-chain reading request in the business function according to the transaction attribute information and the device attribute information corresponding to the N candidate network devices.

The generation module 912 may include an obtaining unit 94b, a sorting unit 95b, and a second generation unit 96b.

The obtaining unit 94b is configured to obtain, from the device attribute information of the N candidate network devices, credibilities corresponding to the N candidate network devices.

The sorting unit 95b is configured to sort, according to a descending order of the credibilities corresponding to the N candidate network devices, request generation templates corresponding to the N candidate network devices.

The second generation unit 96b is configured to add sorted request generation templates corresponding to the N candidate network devices to a device list; and generate the first off-chain reading request in the business function according to the device list and the transaction attribute information.

In some embodiments, the second generation unit 96b is specifically configured to obtain a protocol address of the cross-chain communication protocol according to a protocol identifier of the cross-chain communication protocol in the transaction attribute information; generate callback data according to content requested by the original reading request; and generate the first off-chain reading request in the business function according to the protocol address, the device list, a function identifier of the data verification function, extra data, and the callback data, where the protocol address, the device list, and the callback data in the first off-chain reading request are configured for instructing the terminal device to obtain the transaction data packet through the target network device; the function identifier and the extra data in the first off-chain reading request are configured for instructing the terminal device to request to invoke the data verification function; the transaction data packet and the extra data are used as parameters in the data verification function; and the data verification function is configured for verifying the validity of the transaction data packet through the extra data.

In this application, the node device in the blockchain network pre-generates a set of generalized cross-chain communication protocols. The cross-chain communication protocol is configured for indicating how to securely read the off-chain data through the blockchain network. For example, the cross-chain communication protocol includes the business function configured for issuing an off-chain reading request and the data verification function configured for verifying the off-chain data. The off-chain data can be securely read through the cross-chain communication protocol to ensure the security of the read transaction data, and on-chain and off-chain interoperability can be realized. Specifically, when the terminal device needs to read the target transaction data, the terminal device may transmit the original reading request about the target transaction data to the node device in the blockchain network. The original reading request carries the transaction attribute information of the target transaction data. After receiving the original reading request, the node device may determine, by invoking the business function in the cross-chain communication protocol, whether the target transaction data is the off-chain data of the blockchain network. If it is determined that the target transaction data is the off-chain data of the blockchain network, the foregoing cross-chain communication protocol may be queried for the device attribute information of the target network device configured to read the off-chain data of the blockchain network. Further, the node device generates the first off-chain reading request according to the device attribute information and the transaction attribute information and transmits the first off-chain reading request to the terminal device. The first off-chain reading request is configured for instructing the target network device to return the transaction data packet to the terminal device. After receiving the first off-chain reading request, the terminal device reads the transaction data packet from the target network device and forwards the transaction data packet to the node device. The node device invokes the data verification function to verify the validity of the transaction data packet. When the transaction data packet is valid, the node device may parse the transaction data packet to obtain the target transaction data, and transmit the target transaction data obtained through parsing to the terminal device. In this way, the off-chain data may be securely read on the chain, and the validity of the off-chain data (i.e., the target transaction data) can be ensured. Meanwhile, the off-chain data is read through a set of generalized cross-chain communication protocols, data for verification does not need to be separately stored on the chain for each piece of transaction data, interaction details of storing the transaction data to the external device do not need to be sensed by the terminal device, and additional credit assumptions are not needed so that the applicability scope of this application is improved, and generalized reading of the off-chain data may be realized. In addition, the target transaction data is read by the target network device from the external device associated with the blockchain network, and the validity of the target transaction data may be ensured. Therefore, off-chain storage of the target transaction data is possible. In this way, the data storage pressure of the blockchain network may be reduced, and the data storage cost may be reduced.

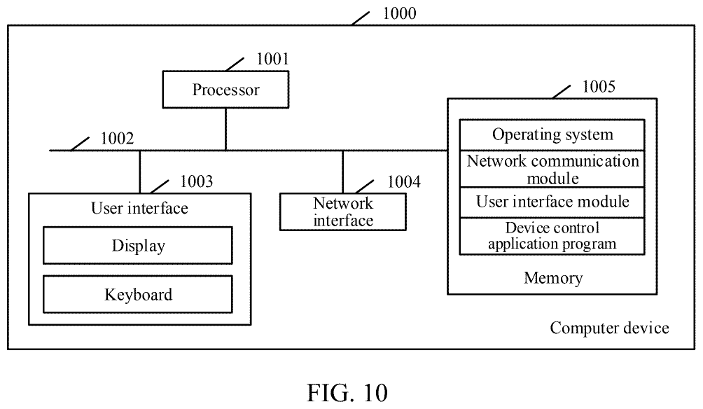

FIG. 10 is a schematic structural diagram of a computer device according to an embodiment of this application. As shown in FIG. 10, a computer device 1000 may include: a processor 1001, a network interface 1004, and a memory 1005. In addition, the foregoing computer device 1000 may further include: a user interface 1003, and at least one communication bus 1002. The communication bus 1002 is configured to implement connection and communication between the components. The user interface 1003 may include a display and a keyboard. In some embodiments, the user interface 1003 may further include a standard wired interface and a standard wireless interface. In some embodiments, the network interface 1004 may include a standard wired interface and a standard wireless interface (such as a WI-FI interface). The memory 1005 may be a high-speed random access memory (RAM), or may be a non-volatile memory, for example, at least one magnetic disk storage. In some embodiments, the memory 1005 may be at least one storage apparatus that is located far away from the foregoing processor 1001. As shown in FIG. 10, as a computer-readable storage medium, the memory 1005 may include an operating system, a network communication module, a user interface module, and a device control application program.

In the computer device 1000 shown in FIG. 10, the network interface 1004 may provide a network communication function. However, the user interface 1003 is mainly configured to provide an input. The processor 1001 may be configured to invoke the device-control application program stored in the memory 1005 to implement:
transmitting an original reading request about target transaction data to a node device in a blockchain network to cause the node device to invoke a business function in a cross-chain communication protocol according to the original reading request, the original reading request carrying transaction attribute information of the target transaction data;
receiving a first off-chain reading request transmitted by the node device, the first off-chain reading request being generated by the node device through the business function; the first off-chain reading request being generated according to the transaction attribute information and device attribute information of a target network device; the device attribute information being obtained by querying the cross-chain communication protocol by the node device when the node device determines, through the business function, that the target transaction data is off-chain data of the blockchain network; and the target network device being a device configured to read the off-chain data of the blockchain network;
reading a transaction data packet from the target network device according to the first off-chain reading request, the transaction data packet being read by the target network device from an external device associated with the blockchain network;
forwarding the transaction data packet to the node device, the node device being configured to verify validity of the transaction data packet based on a data verification function associated with the cross-chain communication protocol to obtain a verification result; and
receiving, if the verification result indicates that the transaction data packet is valid, the target transaction data returned by the node device, the target transaction data returned by the node device being obtained by parsing the transaction data packet by the node device.

During example application of the relevant data obtaining and processing in this application, the informed consent or individual consent of a personal information subject needs to be obtained in strict accordance with the requirements of relevant national laws and regulations, and the subsequent data usage and processing behavior is carried out within the scope of authorization of laws and regulations and the personal information subject. For example, before the transaction attribute information of the target transaction data and the device attribute information of the device (for example, the terminal device, the node device, or the network device) are obtained or used, independent authorization of a user to which the target transaction data belongs and a user to which the device belongs are required.

The computer device 1000 described in this embodiment of this application may perform the foregoing descriptions of the blockchain-based data processing method in the corresponding embodiments, or perform the foregoing descriptions of the blockchain-based data processing apparatus in the corresponding embodiments. Details are not described herein. In addition, the description of beneficial effects of the same method are not described herein again.

In addition, the embodiments of this application further provide a computer-readable storage medium, having a computer program executed by the foregoing blockchain-based data processing apparatus stored therein. The computer program includes program instructions. When executing the foregoing program instructions, the processor can perform the foregoing descriptions of the blockchain-based data processing method in the corresponding embodiments. Therefore, details are not described herein. In addition, the description of beneficial effects of the same method are not described herein again. For technical details that are not disclosed in the embodiments of the computer-readable storage medium involved in this application, reference may be made to the descriptions of the method embodiments of this application.

As an example, the program instructions may be deployed on one computer device for execution, or deployed on at least two computer devices at one site for execution, or executed on at least two computer devices distributed at least two sites and connected by a communication network. The at least two computer devices distributed at the at least two sites and connected by the communication network may form a blockchain network.

The foregoing computer-readable storage medium may be an internal storage unit in the blockchain-based data processing apparatus provided in any one of the foregoing embodiments or the foregoing computer device, for example, a hard disk or an internal memory of the computer device. The computer-readable storage medium may be an external storage device of the computer device, for example, a plug-in hard disk, a smart media card (SMC), a secure digital (SD) card, or a flash card equipped on the computer device. Further, the computer-readable storage medium may further include both the internal storage unit and the external storage device of the computer device. The computer-readable storage medium is configured to store the computer program and other programs and data that are required by the computer device. The computer-readable storage medium may further be configured to temporarily store data that has been outputted or is to be outputted.

The terms “first”, “second”, and the like in the specification, claims, and accompanying drawings of the embodiments of this application are used for distinguishing different media content, and are not used for describing a specific order. In addition, the term “include” and any variant thereof are intended to cover a non-exclusive inclusion. For example, processes, methods, apparatuses, products, or devices including a series of steps or units are not limited to the listed steps or units, but instead, include other steps or units not listed in some embodiments, or include other steps or units inherent to these processes, methods, apparatuses, products, or devices in some embodiments.

The embodiments of this application further provide a computer program product, including a computer program/instruction. The computer program/instruction, when executed by a processor, implements the foregoing descriptions of the blockchain-based data processing method in the corresponding embodiments. Therefore, details are not described herein. In addition, the description of beneficial effects of the same method are not described herein again. For technical details that are not disclosed in the embodiments of the computer program product involved in this application, reference may be made to the descriptions of the method embodiments of this application.

A person skilled in the art may realize that the units and algorithm steps in the examples described in conjunction with the embodiments disclosed herein may be implemented in electronic hardware, computer software, or a combination of the two. To clearly illustrate the interchangeability of hardware and software, the composite and steps of the examples have been described above generally according to functions. Whether the functions are executed in hardware or software depends on particular application and design constraint conditions of the technical solutions. For each particular application, a person skilled in the art may use different methods to achieve the described function, but this implementation shall not be considered outside the scope of this application.

The methods and related apparatuses provided in the embodiments of this application are described with reference to the method flowcharts and/or schematic structural diagrams provided in the embodiments of this application. Specifically, each process and/or block in the method flowcharts and/or schematic structural diagrams and a combination of processes and/or blocks in the flowcharts and/or block diagrams may be implemented by the computer program instructions. These computer program instructions may be provided to a processor of a general-purpose computer, a special-purpose computer, an embedded processing machine, or another programmable network connection device to generate a machine so that instructions executed by the processor of the computer or the another programmable network connection device generate an apparatus configured to implement functions specified in one or more processes of the flowcharts and/or one or more blocks of the schematic structural diagrams. These computer program instructions may alternatively be stored in a computer-readable memory that can direct the computer or another programmable network connection device to operate in a particular manner so that the instructions stored in the computer-readable memory generate an article of manufacture including an instruction apparatus which implements the functions specified in one or more processes of the flowcharts and/or one or more blocks of the schematic structural diagrams. These computer program instructions may alternatively be loaded onto the computer or another programmable network connection device so that a series of operations and steps are performed on the computer or another programmable device to generate computer-implemented processing. Therefore, the instructions executed on the computer or another programmable device provide operations for implementing the functions specified in one or more processes of the flowcharts and/or one or more blocks of the schematic structural diagrams.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A data processing method comprising:
transmitting an original reading request about target transaction data to a node device in a blockchain network to cause the node device to invoke a business function in a cross-chain communication protocol according to the original reading request, the original reading request carrying transaction attribute information of the target transaction data;
receiving an off-chain reading request transmitted by the node device, the off-chain reading request being generated by the node device through the business function and according to the transaction attribute information and device attribute information of a target network device, the device attribute information being obtained by the node device querying the cross-chain communication protocol when determining, through the business function, that the target transaction data is off-chain data of the blockchain network, and the target network device being configured to read the off-chain data of the blockchain network;
reading a transaction data packet from the target network device according to the off-chain reading request, the transaction data packet being read by the target network device from an external device associated with the blockchain network;
forwarding the transaction data packet to the node device, for the node device to verify validity of the transaction data packet based on a data verification function associated with the cross-chain communication protocol, to obtain a verification result; and
receiving, in response to the verification result indicating that the transaction data packet is valid, the target transaction data returned by the node device, the target transaction data being obtained by the node device parsing the transaction data packet.

2. The method according to claim 1, wherein:
the off-chain reading request is a first off-chain reading request; and
reading the transaction data packet includes:
generating a second off-chain reading request adapted to the target network device according to the first off-chain reading request;
transmitting the second off-chain reading request to the target network device, for the target network device to generate a request response message according to the second off-chain reading request;
receiving the request response message returned by the target network device; and
obtaining, in response to the request response message being a response success message, the transaction data packet from the request response message.

3. The method according to claim 2, wherein:
the first off-chain reading request includes a protocol address of the cross-chain communication protocol, a request generation template in the cross-chain communication protocol, and callback data, the request generation template is adapted to the target network device, and the protocol address and the callback data are jointly configured to instruct the target network device to read the target transaction data from the external device; and
generating the second off-chain reading request includes:
in response to the request generation template including a data field and a sender field, replacing the sender field with the protocol address and replacing the data field with the callback data, to obtain an obtaining request about the target transaction data; and
determining the obtaining request as the second off-chain reading request.

4. The method according to claim 2, wherein:
the first off-chain reading request includes a protocol address of the cross-chain communication protocol, a request generation template in the cross-chain communication protocol, and callback data, the request generation template is adapted to the target network device, and the protocol address and the callback data are jointly configured to instruct the target network device to read the target transaction data from the external device; and
generating the second off-chain reading request includes:
adding, in response to the request generation template including a sender field and not containing a data field, content type information configured for declaring a format of a request body to a request header;
adding the data field and the sender field to an initial request body, with the callback data being a field value of the data field in the initial request body and the protocol address being a field value of the sender field in the initial request body, to obtain the request body; and
replacing the sender field in the request generation template with the protocol address to obtain a replaced request generation template, and generating a processing request about the target transaction data according to the replaced request generation template, the request header, and the request body, the processing request being the second off-chain reading request.

5. The method according to claim 2,
wherein the first off-chain reading request includes a plurality of request generation templates corresponding to a plurality of candidate network devices, and the plurality of request generation templates are arranged in the first off-chain reading request according to a descending order of credibilities of the plurality of candidate network devices;
the method further comprising:
obtaining sorting sequence numbers of the plurality of request generation templates in the first off-chain reading request; and
determining one candidate network device of the plurality of candidate network devices that corresponds to one of the plurality of request generation templates that has a smallest sorting sequence number as the target network device.

6. The method according to claim 5, further comprising:
suspending transmission of the second off-chain reading request to remaining network devices in response to the request response message being a response failure message and a state value carried by the request response message being within a first threshold range, the remaining network devices being network devices in the plurality of candidate network devices except the one candidate network device; and
re-determining, in response to the request response message being the response failure message and the state value carried by the request response message being within a second threshold range, the target network device from the remaining network devices according to sorting sequence numbers of the remaining network devices, and re-transmitting the second off-chain reading request to target network device.

7. The method according to claim 6, further comprising:
counting a number of transmitting times of the second off-chain reading request; and
suspending re-determination of the target network device in response to the number of transmitting times being greater than a times threshold and the request response message returned by the target network device being the response failure message.

8. The method according to claim 1, wherein:
the off-chain reading request includes an initial verification function in the cross-chain communication protocol and extra data configured for verifying the transaction data packet; and
forwarding the transaction data packet to the node device includes:
adding the transaction data packet and the extra data to the initial verification function to obtain the data verification function; and
transmitting the data verification function to the node device, for the node device to verify the validity of the transaction data packet in the data verification function by executing the data verification function to obtain the verification result.

9. computer-readable storage medium storing a computer program that, when executed by a processor, causes the processor to implement the method according to claim 1.

10. A data processing method comprising:
receiving an original reading request about target transaction data, the original reading request being transmitted by a terminal device and carrying transaction attribute information of the target transaction data;
invoking a business function in a cross-chain communication protocol according to the original reading request, and querying, in response to the business function indicating that the target transaction data is off-chain data of a blockchain network, the cross-chain communication protocol of the blockchain network for device attribute information of a target network device configured to read the off-chain data of the blockchain network;
generating an off-chain reading request in the business function according to the transaction attribute information and the device attribute information, and transmitting the off-chain reading request to the terminal device, for the terminal device to read a transaction data packet from the target network device according to the off-chain reading request, the transaction data packet being read by the target network device from an external device associated with a node device in the blockchain network;
receiving the transaction data packet transmitted by the terminal device, and verifying validity of the transaction data packet according to a data verification function associated with the cross-chain communication protocol to obtain a verification result; and
parsing, in response to the verification result indicating that the transaction data packet is valid, the transaction data packet to obtain the target transaction data, and returning the target transaction data obtained through parsing to the terminal device.

11. The method according to claim 10, wherein:
the transaction data packet further includes signature information of an institution to which the target network device belongs;
the data verification function includes a data verification rule and a public key of the institution, and the data verification rule is configured for instructing to verify the signature information; and
verifying the validity of the transaction data packet includes:
performing a hash operation on the transaction data packet to obtain a hash value of the transaction data packet;
performing signature verification on the signature information according to the public key of the institution, to obtain signature verification data; and
generating, in response to the hash value of the transaction data packet matching the signature verification data, the verification result indicating that the transaction data packet is valid.

12. The method according to claim 10, wherein:
querying the cross-chain communication protocol includes:
querying the cross-chain communication protocol for device attribute information corresponding to a plurality candidate network devices configured to read the off-chain data of the blockchain network, the plurality of candidate network devices including the target network device; and
generating the off-chain reading request includes:
generating the off-chain reading request according to the transaction attribute information and the device attribute information corresponding to the plurality of candidate network devices.

13. The method according to claim 12, wherein generating the off-chain reading request according to the transaction attribute information and the device attribute information corresponding to the plurality of candidate network devices includes:
obtaining, from the device attribute information of the plurality of candidate network devices, credibilities corresponding to the plurality of candidate network devices;
sorting, according to a descending order of the credibilities, request generation templates corresponding to the plurality of candidate network devices to obtain sorted request generation templates;
adding the sorted request generation templates to a device list; and
generating the off-chain reading request according to the device list and the transaction attribute information.

14. The method according to claim 13, wherein generating the off-chain reading request according to the device list and the transaction attribute information includes:
obtaining a protocol address of the cross-chain communication protocol according to a protocol identifier of the cross-chain communication protocol in the transaction attribute information;
generating callback data according to content requested by the original reading request; and
generating the off-chain reading request according to the protocol address, the device list, a function identifier of the data verification function, extra data, and the callback data, wherein:
the protocol address, the device list, and the callback data in the off-chain reading request are configured for instructing the terminal device to obtain the transaction data packet through the target network device;
the function identifier and the extra data in the off-chain reading request are configured for instructing the terminal device to request to invoke the data verification function;
the transaction data packet and the extra data are used as parameters in the data verification function; and
the data verification function is configured for verifying the validity of the transaction data packet through the extra data.

15. A computer device comprising:
a memory storing a computer program; and
a processor configured to execute the computer program to implement the method according to claim 10.

16. A non-transitory computer-readable storage medium storing a computer program that, when executed by a processor, causes the processor to implement the method according to claim 10.

17. A computer device comprising:
a memory storing a computer program; and
a processor configured to execute the computer program to:
transmit an original reading request about target transaction data to a node device in a blockchain network to cause the node device to invoke a business function in a cross-chain communication protocol according to the original reading request, the original reading request carrying transaction attribute information of the target transaction data;
receive an off-chain reading request transmitted by the node device, the off-chain reading request being generated by the node device through the business function and according to the transaction attribute information and device attribute information of a target network device, the device attribute information being obtained by the node device querying the cross-chain communication protocol when determining, through the business function, that the target transaction data is off-chain data of the blockchain network, and the target network device being configured to read the off-chain data of the blockchain network;
read a transaction data packet from the target network device according to the off-chain reading request, the transaction data packet being read by the target network device from an external device associated with the blockchain network;
forward the transaction data packet to the node device, for the node device to verify validity of the transaction data packet based on a data verification function associated with the cross-chain communication protocol, to obtain a verification result; and
receive, in response to the verification result indicating that the transaction data packet is valid, the target transaction data returned by the node device, the target transaction data being obtained by the node device parsing the transaction data packet.

18. The device according to claim 17, wherein:
the off-chain reading request is a first off-chain reading request; and
the computer is further configured to execute the computer program to, when reading the transaction data packet:
generate a second off-chain reading request adapted to the target network device according to the first off-chain reading request;
transmit the second off-chain reading request to the target network device, for the target network device to generate a request response message according to the second off-chain reading request;
receive the request response message returned by the target network device; and
obtain, in response to the request response message being a response success message, the transaction data packet from the request response message.

19. The device according to claim 18, wherein:
the first off-chain reading request includes a protocol address of the cross-chain communication protocol, a request generation template in the cross-chain communication protocol, and callback data, the request generation template is adapted to the target network device, and the protocol address and the callback data are jointly configured to instruct the target network device to read the target transaction data from the external device; and
the computer is further configured to execute the computer program to, when generating the second off-chain reading request:
in response to the request generation template including a data field and a sender field, replace the sender field with the protocol address and replacing the data field with the callback data, to obtain an obtaining request about the target transaction data; and
determine the obtaining request as the second off-chain reading request.

20. The device according to claim 18, wherein:
the first off-chain reading request includes a protocol address of the cross-chain communication protocol, a request generation template in the cross-chain communication protocol, and callback data, the request generation template is adapted to the target network device, and the protocol address and the callback data are jointly configured to instruct the target network device to read the target transaction data from the external device; and
the computer is further configured to execute the computer program to, when generating the second off-chain reading request:
add, in response to the request generation template including a sender field and not containing a data field, content type information configured for declaring a format of a request body to a request header;
add the data field and the sender field to an initial request body, with the callback data being a field value of the data field in the initial request body and the protocol address being a field value of the sender field in the initial request body, to obtain the request body; and
replace the sender field in the request generation template with the protocol address to obtain a replaced request generation template, and generating a processing request about the target transaction data according to the replaced request generation template, the request header, and the request body, the processing request being the second off-chain reading request.
